(19) United States
(12) Patent Application Publication
(10) Pub. No.: US 2026/0029782 A1
(43) Pub. Date: Jan. 29, 2026

(54) SYSTEMS, APPARATUS, ARTICLES OF MANUFACTURE, AND METHODS FOR SEQUENCE OF EVENT GENERATION FOR A PROCESS CONTROL SYSTEM

(71) Applicant: Fisher-Rosemount Systems, Inc., Round Rock, TX (US)

(72) Inventors: Sergio Diaz, Pflugerville, TX (US); Gary Keith Law, Georgetown, TX (US); Mark Nixon, Round Rock, TX (US); Neil J. Peterson, Austin, TX (US)

(21) Appl. No.: 18/996,777

(22) PCT Filed: Jul. 21, 2022
(86) PCT No.: PCT/US2022/037876

§ 371 Date: Jan. 17, 2025

(51) Int. Cl. G05B 19/418

(52) U.S. Cl. CPC G05B 19/4185; G05B 2219/24033; G05B 2219/25126; G05B 2219/25428

(57) ABSTRACT

Methods, apparatus, systems, and articles of manufacture are disclosed for sequence of event generation for a process control system. An example apparatus includes at least one memory, machine readable instructions, and processor circuitry to at least one of execute or instantiate the machine readable instructions to obtain a first digital signal from a first field device representative of a first sensor data value labeled with a first timestamp generated by the first field device, obtain a second digital signal from a second field device representative of a second sensor data value labeled with a second timestamp generated by the second field device, and store a data association of the first and second sensor data values in a datastore, the data association representative of a sequence of events including an ordering of the first sensor data value and the second sensor data value based on the first and second timestamps.

### RELATED APPLICATIONS

This patent arises from the national stage of International Application No. PCT/US2022/037876, which was filed on Jul. 21, 2022. International Application No. PCT/US2022/037876 is hereby incorporated herein by reference in its entirety. Priority to International Application No. PCT/US2022/037876 is hereby claimed.

### FIELD OF THE DISCLOSURE

This disclosure relates generally to process control systems and, more particularly, to systems, apparatus, articles of manufacture, and methods for sequence of event generation for a process control system.

### BACKGROUND

Distributed control systems monitor and/or control field devices, such as actuators and sensors, in a process control system. When a process upset occurs, events may take place rapidly throughout the process control system. Accurate recording and sequencing of the events to determine a cause of the upset is needed.

### SUMMARY

Systems, apparatus, articles of manufacture, and methods for sequence of event generation for a process control system are disclosed. An example apparatus includes at least one memory, machine readable instructions, and processor circuitry. In some disclosed examples, the processor circuitry is to at least one of execute or instantiate the machine readable instructions to at least obtain a first digital signal from a first field device in a process control system, the first digital signal representative of a first sensor data value labeled with a first timestamp, the first timestamp to be generated by the first field device. In some disclosed examples, the processor circuitry is to at least one of execute or instantiate the machine readable instructions to obtain a second digital signal from a second field device in the process control system, the second digital signal representative of a second sensor data value labeled with a second timestamp, the second timestamp to be generated by the second field device. In some disclosed examples, the processor circuitry is to at least one of execute or instantiate the machine readable instructions to store a data association of the first sensor data value and the second sensor data value in a datastore, the data association representative of a sequence of events associated with the process control system, the sequence of events to include an ordering of the first sensor data value and the second sensor data value based on the first timestamp and the second timestamp.

An example non-transitory machine readable storage medium comprising instructions that, when executed, cause processor circuitry to at least obtain a first digital signal from a first field device in a process control system, the first digital signal representative of a first sensor data value marked with a first timestamp, the first timestamp to be generated by the first field device. In some disclosed examples, the instructions, when executed, cause the processor circuitry to obtain a second digital signal from a second field device in the process control system, the second digital signal representative of a second sensor data value marked with a second timestamp, the second timestamp to be generated by the second field device. In some disclosed examples, the instructions, when executed, cause the processor circuitry to store a data association of the first sensor data value and the second sensor data value in a datastore, the data association representative of a sequence of events associated with the process control system, the sequence of events to include an ordering of the first sensor data value and the second sensor data value based on the first timestamp and the second timestamp.

An example method includes obtaining a first digital signal from a first field device in a process control system, the first digital signal representative of a first sensor data value labeled with a first timestamp, the first timestamp generated by the first field device. In some disclosed examples, the method further includes obtaining a second digital signal from a second field device in the process control system, the second digital signal representative of a second sensor data value labeled with a second timestamp, the second timestamp generated by the second field device. In some disclosed examples, the method further includes storing a data association of the first sensor data value and the second sensor data value in a datastore, the data association representative of a sequence of events associated with the process control system, the sequence of events including an ordering of the first sensor data value and the second sensor data value based on the first timestamp and the second timestamp.

Another example apparatus is disclosed that includes at least one memory. machine readable instructions, and processor circuitry. In some disclosed examples, the processor circuitry is to at least one of execute or instantiate the machine readable instructions to at least, after a determination that a measurement period associated with a field device in a process control system is triggered, record a timestamp at the field device during the measurement period. In some disclosed examples, the processor circuitry is to at least one of execute or instantiate the machine readable instructions to record a sensor measurement associated with the timestamp at the field device. In some disclosed examples, the processor circuitry is to at least one of execute or instantiate the machine readable instructions to cause transmission of a digital signal representative of at least one of the timestamp or the sensor measurement from the field device to an electronic device using a network communication protocol. In some disclosed examples, the processor circuitry is to at least one of execute or instantiate the machine readable instructions to cause a generation of a sequence of events for the field device based on the digital signal.

Another example non-transitory machine readable storage medium is disclosed that comprises instructions that, when executed, cause processor circuitry to at least obtain a first digital signal from a first field device in a process control system, the first digital signal representative of a first sensor data value marked with a first timestamp, the first timestamp to be generated by the first field device. In some disclosed examples, the instructions, when executed, cause the processor circuitry to, after a determination that a measurement period associated with a field device in a process control system is triggered, record a timestamp at the field device during the measurement period. In some disclosed examples, the instructions, when executed, cause the processor circuitry to record a sensor measurement associated with the timestamp at the field device. In some disclosed examples, the instructions, when executed, cause the processor circuitry to cause transmission of a digital signal representative of at least one of the timestamp or the sensor measurement from the field device to an electronic device using a network communication protocol. In some disclosed examples, the instructions, when executed, cause the processor circuitry to cause a generation of a sequence of events for the field device based on the digital signal.

Another example method is disclosed that comprises, after determining that a measurement period associated with a field device in a process control system is triggered, recording a timestamp at the field device during the measurement period. In some disclosed examples, the method further includes recording a sensor measurement associated with the timestamp at the field device. In some disclosed examples, the method further includes transmitting a digital signal representative of at least one of the timestamp or the sensor measurement from the field device to an electronic device using a network communication protocol. In some disclosed examples, the method further includes causing a generation of a sequence of events for the field device based on the digital signal.

### BRIEF DESCRIPTION OF THE DRAWINGS

FIG. 1 is an illustration of a first example process control system to observe events in a process control environment using example field devices coupled to example input/output (I/O) cards.

FIG. 2 is an illustration of a second example process control system to observe events in a process control environment using example field devices coupled to an example controller via an example network.

FIG. 3 is an illustration of a third example process control system to observe events in a process control environment using example field devices and an example I/O system coupled to an example controller.

FIG. 4 is a block diagram of an example implementation of the controller of FIGS. 2 and/or 3.

FIG. 5 is a block diagram of an example implementation of the field devices and/or the I/O system of FIGS. 2 and/or 3.

FIG. 6 depicts a graph of example digital signals associated with the example field devices and/or the example I/O system of FIGS. 2 and/or 3.

FIG. 7 depicts a graph of example analog signals associated with the example field devices and/or the example I/O system of FIGS. 2 and/or 3.

FIG. 8 depicts an example sequence of events associated with an example process control system.

FIG. 9 is a flowchart representative of example machine readable instructions and/or example operations that may be executed by example processor circuitry to implement the example controller of FIGS. 2 and/or 3 to generate a sequence of events associated with a process control system.

FIG. 10 is another flowchart representative of example machine readable instructions and/or example operations that may be executed by example processor circuitry to implement the example controller of FIGS. 2 and/or 3 to generate a sequence of events associated with a process control system.

FIG. 11 is a flowchart representative of example machine readable instructions and/or example operations that may be executed by example processor circuitry to implement the example controller of FIGS. 2 and/or 3 to generate a sequence of events based on sensor measurements from subscribing field devices.

FIG. 12 is a flowchart representative of example machine readable instructions and/or example operations that may be executed by example processor circuitry to implement the example field device of FIGS. 2 and/or 3 to cause a generation of a sequence of events associated with a process control system.

FIG. 13 is another flowchart representative of example machine readable instructions and/or example operations that may be executed by example processor circuitry to implement the example field device of FIGS. 2 and/or 3 to cause a generation of a sequence of events associated with a process control system.

FIG. 14 is a flowchart representative of example machine readable instructions and/or example operations that may be executed by example processor circuitry to implement the example field device of FIGS. 2 and/or 3 to obtain sensor measurement(s) satisfying threshold(s).

FIG. 15 is flowchart representative of example machine readable instructions and/or example operations that may be executed by example processor circuitry to implement the example field device of FIGS. 2 and/or 3 to cause a generation of a sequence of events associated with a process control system based on minimum and/or maximum value(s) of sensor measurement(s).

FIG. 16 is a flowchart representative of example machine readable instructions and/or example operations that may be executed by example processor circuitry to implement the example field device of FIGS. 2 and/or 3 to implement event storm prevention.

FIG. 17 is a block diagram of an example processing platform including processor circuitry structured to execute the example machine readable instructions and/or the example operations of FIGS. 9, 10, 11, 13, and/or 15 to implement the example controller of FIGS. 2 and/or 3.

FIG. 18 is a block diagram of an example processing platform including processor circuitry structured to execute the example machine readable instructions and/or the example operations of FIGS. 12, 13, 14, 15, and/or 16 to implement the example field device of FIGS. 2 and/or 3.

FIG. 19 is a block diagram of an example implementation of the processor circuitry of FIGS. 17 and/or 18.

FIG. 20 is a block diagram of another example implementation of the processor circuitry of FIGS. 17 and/or 18.

FIG. 21 is a block diagram of an example software distribution platform (e.g., one or more servers) to distribute software (e.g., software corresponding to the example machine readable instructions of FIGS. 9, 10, 11, 12, 13, 14, 15, and/or 16) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

### DETAILED DESCRIPTION

In general, the same reference numbers will be used throughout the drawing(s) and accompanying written description to refer to the same or like parts. The figures are not to scale.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

As used herein “substantially real time” refers to occurrence in a near instantaneous manner recognizing there may be real world delays for computing time, transmission, etc. Thus, unless otherwise specified, “substantially real time” refers to real time +/−1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “processor circuitry.” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmable with instructions to perform specific operations and including one or more semiconductor-based logic devices (e.g., electrical hardware implemented by one or more transistors). Examples of processor circuitry include programmable microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of processor circuitry is/are best suited to execute the computing task(s).

Process control systems (sometimes referred to as industrial control systems) are systems that have the ability to monitor and adjust a process or operation in a process control environment (e.g., a factory, a plant, a refinery, etc.) to achieve a desired output. For example, the desired output can include an assembly and/or manufacturing of a substance (e.g., a chemical substance, composition, or compound), product, or good. In some examples, process control systems may be used to monitor and/or control different aspects of an operation to be conducted in a process control environment such as, for example, manufacturing components, processing raw chemical materials, etc.

Some process control systems may be controlled and/or otherwise implemented by a distributed control system (DCS). A DCS may include a system of sensors, controllers, and associated electronic or computing systems distributed throughout the process control environment. Individual components of the DCS can be communicatively coupled to one(s) of each other via a process control network, which can be implemented by one or more bus networks, protocols, etc.

Process control systems are growing increasingly complex as individual components of the process control systems are developed and deployed with increased data acquisition resolution, processing power, and signal conditioning. Process control systems typically contain at least one controller with accompanying inputs and outputs, which allow the controller(s) to acquire signals from various field devices and/or instruments and/or control the various output field devices and/or instruments.

As used herein, the terms “field device” and “instrument” are used interchangeably and refer to assemblies and/or devices (e.g., electronic devices) such as, for example, actuators, actuator assemblies, actuator controllers, actuator positioners, sensors (e.g., rate and/or speed sensors, level sensors, pressure sensors, temperature sensors, etc.), transmitters, valve assemblies, etc., that may be used throughout a process control system to measure and/or control different aspects (e.g., other field devices or process control components) of the process control system. By way of example, a field device, such as a valve (e.g., a valve assembly, a fluid flow control assembly, etc.), may include both electrical and mechanical components. The valve may include electrical components such as a digital valve positioner, a flow rate sensor, a pressure sensor, a controller (e.g., a valve controller), etc., and the valve may include mechanical components such as an actuator. In some examples, the field device may be a sensor monitoring aspect(s) of the valve, such as a pressure sensor, a temperature sensor, etc.

Process control systems may be detrimentally affected by process control failures. Process control failures can result from a multitude of causes such as, for example, continuous operation, environmental factors, manufacturing defects, etc. In some instances, a failure associated with a first field device may start a chain reaction of events associated with second field device(s) in the same process (or a different process) as the first field device. The events may include failures of other field device(s), emergency shutdown operation(s), etc., and/or any combination(s) thereof. Such a chain reaction of events may be referred to herein as a sequence of events (SOE).

Some DCS and safety instrumented systems (SIS) may capture the SOE from field devices. For instance, an Input/Output (I/O) card (e.g., a programmable logic controller (PLC) I/O card) may be coupled to a field device. The I/O card may capture an event from the field device based on observed changes in physical signals (e.g., analog signals) from the field device, such as current (e.g., an electrical current measurement) or voltage (e.g., an electrical voltage measurement) as processed by the I/O card. For example, the I/O card may obtain a first event based on a first voltage from the field device at a first time, a second event based on a second voltage from the field device at a second time after the first time, etc. In this example, the I/O card may generate an SOE by arranging the events in sequence based on the respective times at which the voltages are observed.

With the introduction of digital field devices in process control systems using network communication protocols (e.g., Ethernet), I/O cards are no longer able to observe the changes in analog signals from the field devices. For instance, the I/O cards may obtain data packets or messages from the field devices instead of analog signals. Additionally and/or alternatively, if the field devices are connected in a process control system via a network interface, such as a network switch or edge gateway, there may be no I/O cards available for the capture and logging of the SOE along with additional analog device information (e.g., current signals, voltage signals, etc.).

Examples disclosed herein include distributed capture of SOE from digital (e.g., fully digital) field devices for discrete process parameters (e.g., an open or close valve parameter that may have a first current/voltage to represent an open condition and a second current/voltage to represent a closed condition, etc.) and/or analog process parameters (e.g., a pressure parameter that may have pressure measurements be represented by numerical values in a range of 4-20 milliamps (mA), 0-5 volts direct current (VDC), etc.). In some disclosed examples. SOE configuration(s), setting(s), etc., can be set at the field device level for improved granularity of SOE data collection. For example, field devices in a process control system can be configured to report and/or otherwise transmit values of process parameters differently based on safety considerations and requirements.

In some disclosed examples, a field device can provide SOE data, information, etc., to an electronic device, such as a controller or network interface (e.g., a network switch, an edge gateway, etc.). For example, SOE data, information, etc., can include data values of discrete parameters, analog parameters, and/or associated timestamps. In some disclosed examples, a field device can generate a data value (e.g., a discrete data value, a floating point value, etc.) based on a sensor measurement (e.g., a pressure measurement, a temperature measurement, etc.) at various time intervals or quantas.

In some disclosed examples, a field device can generate a data value associated with a sensor measurement at a first time, a second time, etc. For example, the first time can be an initial time at a beginning of a data capture or measurement period and the second time can be a current or instant time during the data capture/measurement period for comparison purposes. In some disclosed examples, a field device can generate a first timestamp to correspond to the first time, a second timestamp to correspond to the second time, etc.

Advantageously, in examples disclosed herein, a field device can generate timestamps at the field device for events observed locally at the field device. Such local timestamp generation is an improvement over examples in which a remote controller generates a timestamp to mark when an event from the field device is received rather than when the event occurred. In some disclosed examples, field devices can be synchronized to an electronic device and/or other field device(s) using a time protocol, such as Network Time Protocol (NTP), Highway Addressable Remote Transducer (HART) protocol, etc., for enhanced data collection accuracy.

In some disclosed examples, a field device can report data values at the beginning, end, and/or during a measurement period. For example, a field device can report (i) a first data value representative of a first pressure measurement, (ii) a first timestamp associated with the beginning of the measurement period, and/or (iii) a second timestamp associated with the first pressure measurement. Advantageously, an electronic device receiving data from the field device can determine changes in the data based on the first pressure measurement and/or one(s) of the timestamps.

In some disclosed examples, a field device can report and/or otherwise transmit data values to an electronic device based on data threshold(s). For example, a field device can transmit a discrete event, such as an analog data value representative of a logic zero or one, based on whether an analog process parameter is above a threshold, below a threshold, or between threshold(s). In some disclosed examples, a field device can transmit a non-discrete event, such as a floating point event (e.g., a reporting of a value based on a 4-20 mA range, a value based on a 0-5 V range, etc.), based on whether an analog process parameter is above a threshold, below a threshold, or between threshold(s). For example, a field device can transmit a current or voltage value to an electronic device based on a determination that the current or voltage value is above a threshold (e.g., a current threshold, a voltage threshold, etc.), below a threshold, or between threshold(s).

In some disclosed examples, a field device can reduce and/or otherwise eliminate an occurrence of an event storm. An event storm may occur in a process control network when multiple field devices generate events at substantially the same time and may thus flood the process control network with redundant network traffic. By way of example, a fluid flow control assembly (e.g., a fluid pump with a first sensor) can be in a process with a first field device (e.g., a first valve with a first sensor) and a second field device (e.g., a second valve with a second sensor). The fluid flow control assembly may undergo and/or otherwise experience an event, such as a spike in pressure of fluid flowing through the fluid flow control assembly. The first field device and the second field device may also observe the same spike in pressure relatively quickly after the fluid flow control assembly experiences the event. In some disclosed examples, the first field device and the second field device can receive the event from the fluid flow control assembly and disregard generation of their own events to avoid flooding a process control network with extraneous, repetitive, or redundant events.

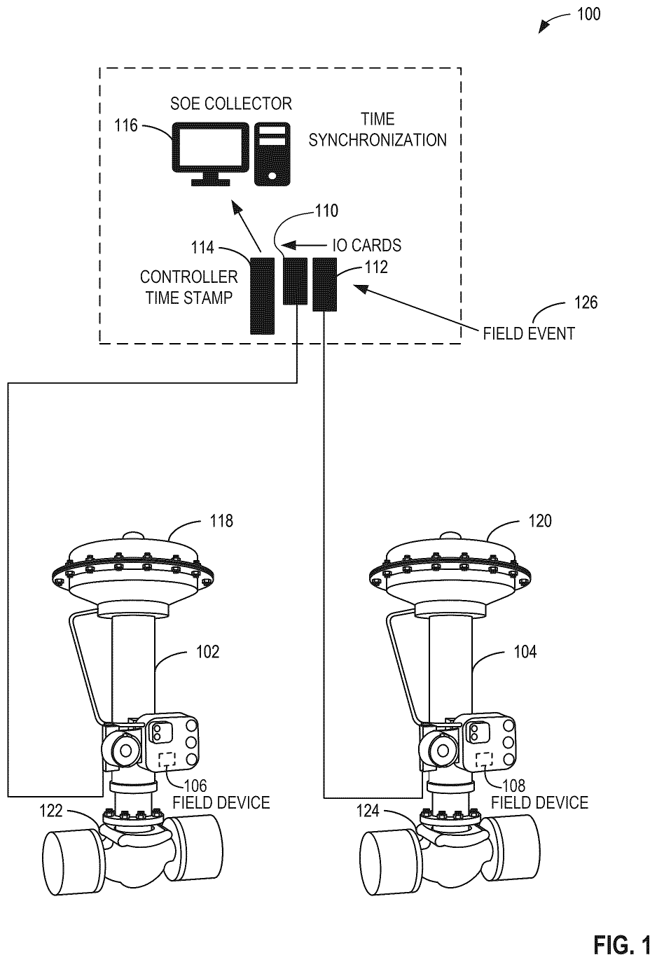

Turning to the figures, FIG. 1 is an illustration of a first example process control system 100 to observe events in a process control environment. For example, the first process control system 100 can be used to control and/or monitor process(es), operation(s), etc., in a process control environment, such as a factory, plant, etc. The first process control system 100 includes a first example fluid flow control assembly 102, a second example fluid flow control assembly 104, a first example field device 106, a second example field device 108, a first example Input/Output (I/O) card 110, a second example I/O card 112, an example controller 114, and an example computing system 116.

The fluid flow control assemblies 102, 104 of the illustrated example are process control valves, which can include an example actuator (e.g., a pneumatic actuator, a hydraulic actuator, etc.) 118, 120, an example valve 122, 124, etc. The fluid flow control assemblies 102, 104 of the illustrated example include a respective one of the field devices 106, 108. The field devices 106, 108 of the illustrated example are electronic devices that monitor and/or control physical equipment in the process control environment, such as the fluid flow control assemblies 102, 104. For example, the first field device 106 can be a transmitter (e.g., a transmitter interface, a transmitter circuitry, etc.) associated with a position sensor of the first valve 122, and/or, more generally, the first fluid flow control assembly 102. In some examples, the first field device 106 can transmit discrete values (e.g., discrete data values), such as a current or voltage representative of a logic zero or one, to the first I/O card 110 based on whether the first valve 122 is open or closed. For example, the first field device 106 can transmit a first voltage of 10 volts direct current (VDC) based on a first determination that the first valve 122 is closed and a second voltage of 0 V based on a second determination that the first valve 122 is open.

In some examples, the second field device 108 can be a transmitter associated with a pressure sensor (e.g., a pressure transducer) of the second valve 124, and/or, more generally, the second fluid flow control assembly 104. For example, the second field device 108 can transmit a continuous or non-discrete value, such as a current or voltage in a range of current values or voltage values, based on pressure measurements from the pressure sensor.

The first field device 106 of the illustrated example is coupled to the first I/O card 110. The second field device 108 of the illustrated example is coupled to the second I/O card 112. The I/O cards 110, 112 can identify an example field event 126 at one(s) of the fluid flow control assemblies 102, 104 based on changes in analog signals from the field devices 106, 108. For example, the field event 126 (or more generally the event 126) can be a relatively fast increase in pressure (e.g., a pressure spike) in fluid flowing through at least one of the first valve 122 or the second valve 124.

The I/O cards 110, 112 are electronic devices that convert analog signals from the field devices 106, 108 into digital data that can be provided to the controller 114. For example, the I/O cards 110, 112 and the controller 114 can be coupled together on a backplane (e.g., a programmable logic controller (PLC) backplane) or backplane system to effectuate communication of data between the I/O cards 110, 112 and the controller 114. The controller 114 of the illustrated example is in communication with the computing system 116. For example, the computing system 116 can be a server, a personal computer, a workstation, a laptop, a mobile device (e.g., a smartphone, a tablet computer, etc.), etc. In some examples. the computing system 116 can execute an application (e.g., a process control system application) to control and/or monitor the first process control system 100. In some examples. the application can include a graphical user interface (GUI) to facilitate interaction between a user (e.g., an engineer, a technician, maintenance personnel, etc.) and the first process control system 100.

In example operation, the field devices 106, 108 report discrete signals or analog signals to the I/O cards 110, 112, which, in turn, report changes in values of the discrete signals or analog signals to the controller 114. For example, the first field device 106 can transmit a first discrete signal, such as a voltage signal representative of a logic one, to the first I/O card 110 at a first time. The first I/O card 110 can transmit first data representative of the logic one to the controller 114. The controller 114 can timestamp the first data by generating a first timestamp. The controller 114 can transmit the first data and/or the first timestamp to the computing system 116.

In some examples, the first field device 106 can transmit a second discrete signal, such as a voltage signal representative of a logic zero, to the first I/O card 110 at a second time after the first time. The first I/O card 110 can transmit second data representative of the logic zero to the controller 114. The controller 114 can timestamp the second data by generating a second timestamp. The controller 114 can transmit the second data and/or the second timestamp to the computing system 116. The computing system 116 can generate a sequence of events based on an arrangement of the first data and the second data using the first timestamp and the second timestamp. For example, the sequence of events can include a first event, which can include the first data and the first timestamp, followed by a second event, which can include the second data and the second timestamp.

In some examples, the first process control system 100 includes a network of field devices that communicate with one(s) of each other using a network communication protocol, such a communication protocol from the Internet protocol suite. For example, network-enabled field devices (e.g., a field device capable of sending and/or receiving data using a network communication protocol) can communicate to a controller, such as the controller 114, without an I/O card, such as the I/O cards 110, 112. In some examples, the network-enabled field devices can transmit data to and/or receive data from the controller 114 via a network interface, such as a network switch, an edge gateway, etc.

The aforementioned Internet protocol suite can include Transmission Control Protocol/Internet Protocol (TCP/IP) (e.g., Ethernet or Ethernet protocol), User Datagram Protocol (UDP), etc. In some examples, the network of field devices can communicate with one(s) of each other using an Ethernet-based protocol, such as Profinet. In some examples, the network of field devices can communicate with one(s) of each other using any other type of communication protocol, such as Modbus, Profibus, Controller Area Network (CAN), CANopen, CAN in Automation (CiA), a communication protocol based on Society of Automotive Engineers standard SAE J1939 (e.g., J1939 communication protocol), etc.

In some examples in which the field devices 106, 108 are network devices (e.g., the field devices 106, 108 communicate to each other and/or the controller 114 via a network communication protocol), network latency and packet collisions can cause events from the field devices 106, 108 to be recorded by the controller 114 out of sequence if the controller 114 timestamps the events as they are received by the controller 114. For example, the first field device 106 can generate a first event at a first time; the first field device 106 can transmit the first event to the controller 114 at a second time; the controller 114 can receive the first event at a third time; and the controller 114 can generate a first timestamp for the first event at a fourth time. In some examples, the time difference between the first time and the fourth time can cause an inaccurate generation of a sequence of events if the controller 114 records a second event from the second field device 108 with a timestamp ahead of the first timestamp even if the first event prior to the second event. For example, the first event may arrive to the controller 114 later than the second event due to network latency, packet collisions, etc.

In some examples in which the field devices 106, 108 are network devices, the field devices 106, 108 can be time synchronized at high fidelity for the field devices 106, 108 to timestamp their own changes in signal values (e.g., changes in discrete signal values, analog signal values, etc.) and communicate the timestamped values to the controller 114. However, such a time synchronization schema may be limited to discrete field devices (e.g., the first field device 106) because the fidelity of a network-based analog field device (e.g.,

the second field device 108) may be unable to report their analog signal values within desired rates. For example, a network-based analog field device may have a data reporting rate in a range of once every 50 milliseconds (ms) to once per second, which may be too slow to achieve accurate sequence of event generation.

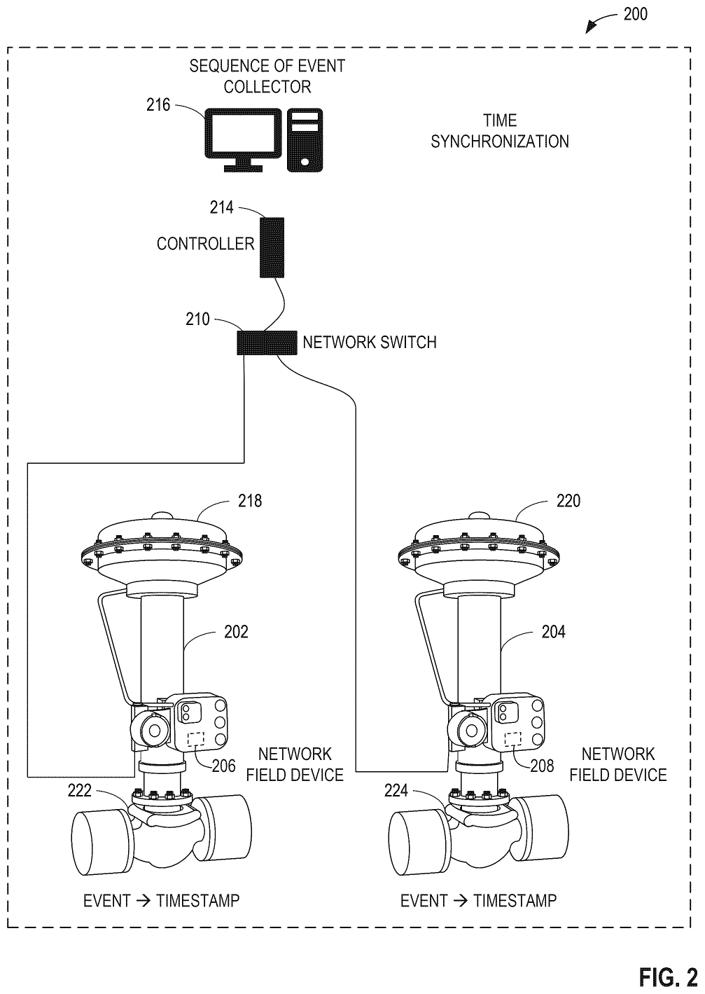

FIG. 2 is an illustration of a second example process control system 200 to observe events in a process control environment. For example, the second process control system 200 can be used to control and/or monitor process(es), operation(s), etc., in a process control environment, such as a factory, plant, etc. The second process control system 200 includes a third example fluid flow control assembly 202, a fourth example fluid flow control assembly 204, a third example field device 206, a fourth example field device 208, an example network switch 210, an example controller 214, and an example computing system 216. The third fluid flow control assembly 202 includes the third field device 206, a third example actuator 218 and a third example valve 222. The fourth fluid flow control assembly 204 includes the fourth field device 208, a fourth example actuator 220 and a fourth example valve 224.

In some examples, the third fluid flow control assembly 202, the third actuator 218, and the third valve 222 can correspond to the first fluid flow control assembly 102, the first actuator 118, and the first valve 122 of FIG. 1, respectively. In some examples, the fourth fluid flow control assembly 204, the fourth actuator 220, and the fourth valve 224 can correspond to the second fluid flow control assembly 104, the second actuator 120, and the second valve 124 of FIG. 1, respectively. In some examples, the controller 214 of FIG. 2 can correspond to the controller 114 of FIG. 1. In some examples, the computing system 216 of FIG. 2 can correspond to the computing system 116 of FIG. 1.

In the illustrated example of FIG. 2, the third field device 206 and the fourth field device 208 are network-based field devices. For example, the third field device 206 and the fourth field device 208 can communicate to each other based on a network communication protocol, such as TCP/IP. In the illustrated example, the third field device 206 and the fourth field device 208 are communicatively coupled to each other via the network switch 210. In the illustrated example, the third field device 206 and/or the fourth field device 208 is/are communicatively coupled to the controller 214 via the network switch 210.

In some examples, the network switch 210 can be implemented by a switch (e.g., a network switch), a router (e.g., a network router), a gateway (e.g., a network gateway, an edge gateway, etc.), an access point (e.g., a wired access point, a wireless access point (WAP), etc.). For example, the network switch 210 can effectuate wired communication and/or wireless communication (e.g., Wireless Fidelity (Wi-Fi) communication, cellular communication, etc.). In some examples, at least one of the third field device 206, the fourth field device 208, the network switch 210, the controller 214, or the computing system 216 can implement a network (e.g., a computer network, a process control network, etc.). For example, the network can be implemented using any suitable wired and/or wireless network(s) including, for example, one or more data buses, one or more Local Area Networks (LANs), one or more wireless LANs (WLANs), one or more cellular networks, one or more private networks, one or more public networks, one or more optical networks, etc., and/or any combination(s) thereof. Additionally and/or alternatively, the network can be implemented by the Internet.

In some examples, the third field device 206 can generate respective event(s) based on measurement(s) (e.g., sensor measurement(s)) associated with process(es), operation(s), etc., in the process control environment. For example, the third field device 206 can generate an event based on a position of the third actuator 218, the third valve 222, etc. In some examples, the event can be implemented by data packet(s) (e.g., one or more TCP/IP data packets, one or more Ethernet packets, etc.), message(s) (e.g., one or more data messages, one or more TCP/IP data messages, one or more Ethernet messages, etc.), etc. For example, the data packet/message, etc., can include data (e.g., a header, a payload, etc.) such as a logic zero or logic one based on whether the position of the third actuator 218 is open or closed. In some examples, the data packet/message can include data such as an analog current value (e.g., an analog current value in a range of 0-20 mA, 4-20 mA, etc.), a voltage value (e.g., a voltage value in a range of 0-5 V or VDC, 0-10 V or VDC, etc.), etc. For example, the analog current value and/or the voltage value can be representative of a logic zero or a logic one associated with an open/close determination of the third actuator 218, the third valve 222, etc.

In some examples, the data packet/message can include identification information of the third field device 206, and/or, more generally, the third fluid flow control assembly 202. For example, the identification information can include an identifier (ID) of the third field device 206, the third actuator 218, the third valve 222, and/or, more generally, the third fluid flow control assembly 202. In some examples, the identification information can include a media access control (MAC) address, an IP address, an IP port, etc., associated with the third field device 206. In some examples, the data packet/message can include a sequence number of a quanta or time interval. For example, the third field device 206 can increment a value of a counter at the beginning of each time interval and include the value of the counter in a generated event. In some examples, the data packet/message can include a type of an event. For example, the event can have a type of general sensor data reporting. failure reporting. data exceeding threshold(s) reporting, alert reporting. prognostic health monitoring reporting, maintenance needed reporting, etc., and/or any combination(s) thereof.

In some examples, the third field device 206 can generate and timestamp events periodically. For example, at fixed quantas or time intervals (e.g., every 5 ms, 10 ms, 25 ms, 50 ms, 100 ms, 1 second(s), etc.) the third field device 206 can obtain a sensor measurement from a position sensor monitoring the third valve 222; generate a timestamp; generate an event (e.g., data representative of the timestamp and/or whether the third valve 222 is open or closed) based on the sensor measurement and the timestamp; and cause transmission of the event to the controller 214 via the network switch 210. In some examples. the third field device 206 can generate a first timestamp at a beginning of a time interval and a second timestamp at a current time in the time interval (or at an end of the time interval). The third field device 206 can label, mark, and/or otherwise associate the generated timestamps with the corresponding sensor measurements. Alternatively, the third field device 206 may generate events asynchronously or aperiodically, such as in response to a request from the controller 214 for generation of the events.

Advantageously, the third field device 206 can generate timestamps substantially simultaneously after capture of a sensor measurement to achieve improved accuracy with respect to examples in which the controller 214 is to generate timestamps when events are received from field devices (rather than when the events actually occurred). Advantageously, a receiving electronic system, such as the controller 214, can determine change(s) in sensor measurement(s) associated with the third fluid flow control assembly 202 (as well as the associated time of the change(s)) based on the sensor measurement(s), the timestamp(s) included in the event, and/or the sequence number for the time interval. Advantageously, time synchronization among the field devices 206, 208 does not need to be relatively high with techniques described herein. For example, a first resolution for time synchronization (e.g., 50 ms, 100 ms, etc.) between the clock times of the field devices 206. 208 can be greater than a second resolution for timestamping (e.g., 5 ms, 10 ms, etc.) by the individual field devices 206, 208.

Advantageously, examples described herein extend sequence of event techniques to analog process parameters, such as process parameters based on pressure sensor measurements, rate sensor measurements (e.g., fluid flow rate, pump speed, engine speed, etc.), temperature sensor measurements, etc. For example, examples described herein can generate a sequence of events based on 0-20 mA and/or 4-20 mA analog signal values, 0-5 V and/or 0-10 V analog signal values, etc., that can correspond to process parameters (e.g., pressure, rate, temperature, etc., process parameters).

In some examples. the controller 214 and/or the computing system 216 can generate a sequence of events based on analog signals using thresholds. For example, the fourth field device 208 can generate respective event(s) based on measurement(s) (e.g., sensor measurement(s)) associated with process(es), operation(s), etc., in the process control environment and transmit the event(s) to the controller 214 (and/or the computing system 216 via the controller 214). The controller 214 and/or the computing system 216 can generate the sequence of events based on events obtained from the field devices 206, 208.

By way of example, the fourth field device 208 can generate an event based on a pressure (or temperature or other parameter) of fluid flowing through the fourth valve 224. In some examples, the event can be implemented by data packet(s) (e.g., one or more TCP/IP data packets, one or more Ethernet packets, etc.), message(s) (e.g., one or more data messages, one or more TCP/IP data messages, one or more Ethernet messages, etc.), etc. In some examples, the data packet/message, etc., can include data (e.g., a header, a payload. etc.) such as a logic zero or logic one based on whether the pressure is outside a defined threshold. For example, the fourth field device 208 can determine that a pressure sensor measurement of 500 pounds per square inch (PSI) from a pressure sensor monitoring the fourth valve 224 is greater than a threshold (e.g., a pressure threshold) of 250 PSI. In some examples, the fourth field device 208 can generate a discrete event including data representative of a digital one to indicate that the pressure sensor measurement is outside the predefined threshold of 250 PSI. Alternatively, if the fourth field device 208 determines that the pressure sensor measurement is 150 PSI, the fourth field device 208 can generate a discrete event including data representative of a digital zero to indicate that the pressure sensor measurement is within the predefined threshold of 250 PSI.

In some examples, the fourth field device 208 can utilize different thresholds for the same process parameter. For example, the fourth field device 208 can utilize a first threshold of 100 PSI, a second threshold of 250 PSI, a third threshold of 500 PSI, etc. By way of example, if the fourth field device 208 determines that the pressure sensor measurement is 300 PSI, then the fourth field device 208 can generate (i) a first discrete event including data representative of a digital one to indicate that the first threshold is satisfied because 300 PSI is greater than the first threshold of 100 PSI, (ii) a second discrete event including data representative of a digital one to indicate that the second threshold is satisfied because 300 PSI is greater than the second threshold of 250 PSI, and/or (iii) a third discrete event including data representative of a digital zero to indicate that the third threshold is not satisfied because 300 PSI is less than the third threshold of 500 PSI.

In some examples, the first discrete event can include (i) a first timestamp corresponding to a beginning of a time interval, (ii) a second timestamp corresponding to a time at which the first discrete event occurred, and/or (iii) an analog signal value (e.g., an analog signal of 8 mA for a 4-20 mA sensor) corresponding to the 300 PSI. In some examples, the second discrete event can include (i) the first timestamp, (ii) a third timestamp corresponding to a time at which the second discrete event occurred, and/or (iii) the analog signal value. In some examples, the third discrete event can include (i) the first timestamp. (ii) a fourth timestamp corresponding to a time at which the third discrete event occurred, and/or (iii) the analog signal value.

In some examples, the fourth field device 208 can report minimum and/or maximum values for process control parameters. By way of example, the fourth field device 208 can utilize a threshold of 250 PSI. The fourth field device 208 can generate a first timestamp associated with a beginning of a time interval or measurement time period. The fourth field device 208 can obtain sensor measurements throughout the measurement time period. The fourth field device 208 can generate a second timestamp associated with an end of the time interval/measurement time period. The fourth field device 208 can identify a minimum value of the fluid pressure of the fourth valve 224 and/or a maximum value of the fluid pressure of the fourth valve 224 from the first timestamp to the second timestamp. In some examples, the fourth field device 208 can identify a maximum value (e.g., 500 PSI) of the fluid pressure that exceeded the threshold of 250 PSI. In some examples, the fourth field device 208 can identify a minimum value (e.g., 80 PSI) of the fluid pressure that did not exceed the threshold of 250 PSI.

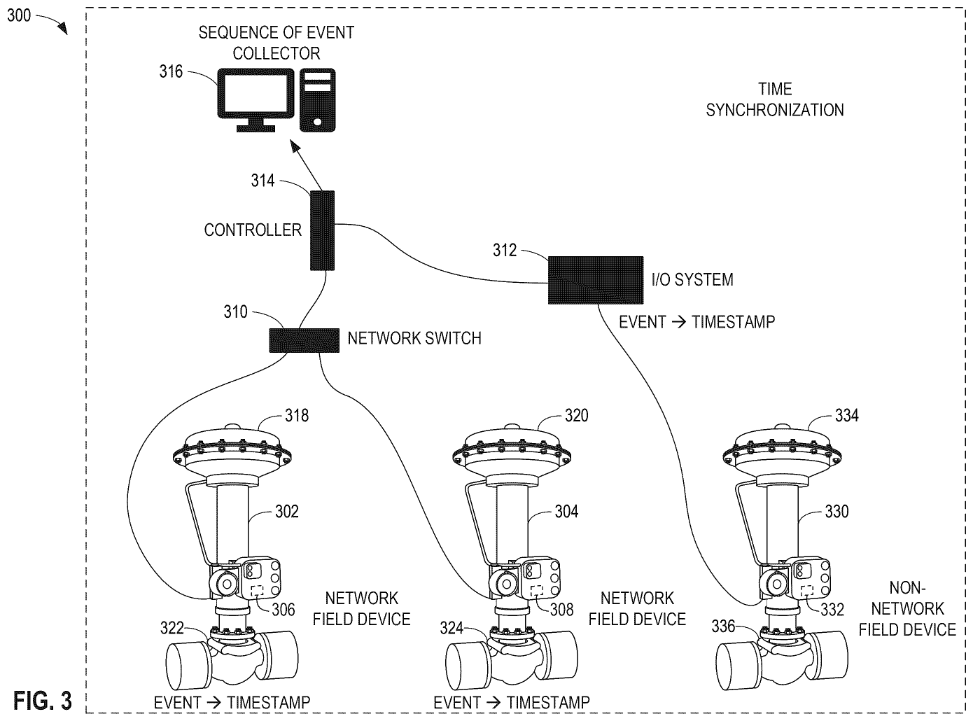

FIG. 3 is an illustration of a third example process control system 300 to observe events in a process control environment. For example, the third process control system 300 can be used to control and/or monitor process(es), operation(s), etc., in a process control environment, such as a factory, plant, etc. The third process control system 300 includes a fifth example fluid flow control assembly 302, a sixth example fluid flow control assembly 304, a seventh example fluid flow control assembly 330, a fifth example field device 306, a sixth example field device 308, a seventh example field device 332, an example network switch 310, an example I/O system 312, an example controller 314, and an example computing system 316. The fifth fluid flow control assembly 302 includes the fifth field device 306, a fifth example actuator 318 and a fifth example valve 322. The sixth fluid flow control assembly 304 includes the sixth field device 308, a sixth example actuator 320 and a sixth example valve 324. The seventh fluid flow control assembly 330 includes the seventh field device 332, a seventh example actuator 334, and a seventh example valve 336.

In some examples, the fifth fluid flow control assembly 302, the fifth field device 306, the fifth actuator 318, and the fifth valve 322 can correspond to the third fluid flow control assembly 202, the third field device 206, the third actuator 218, and the third valve 222 of FIG. 2, respectively. In some examples, the sixth fluid flow control assembly 304, the sixth field device 308, the sixth actuator 320, and the sixth valve 324 can correspond to the fourth fluid flow control assembly 204, the fourth field device 208, the fourth actuator 220, and the fourth valve 224 of FIG. 2, respectively.

In some examples, the seventh actuator 334 can correspond to the first actuator 118, the second actuator 120, the third actuator 218, the fourth actuator 220, the fifth actuator 318, and/or the sixth actuator 320. In some examples, the seventh valve 336 can correspond to the first valve 122, the second valve 124, the third valve 222, the fourth valve 224, the fifth valve 322, and/or the sixth valve 324.

In some examples, the network switch 310 of FIG. 3 can correspond to the network switch 210 of FIG. 2. In some examples, the controller 314 of FIG. 3 can correspond to the controller 114 of FIG. 1 and/or the controller 214 of FIG. 2. In some examples, the computing system 316 of FIG. 3 can correspond to the computing system 116 of FIG. 1 and/or the computing system 216 of FIG. 2.

In the illustrated example of FIG. 3, the fifth field device 306 and the sixth field device 308 are network-based field devices. For example, the fifth field device 306 and the sixth field device 308 can communicate to each other based on a network communication protocol, such as TCP/IP. In the illustrated example, the fifth field device 306 and the sixth field device 308 are communicatively coupled to each other via the network switch 310. In the illustrated example, the fifth field device 306 and/or the sixth field device 308 is/are communicatively coupled to the controller 314 via the network switch 210.

In the illustrated example of FIG. 3, the seventh field device 332 is a non-network-based field device. For example, the seventh field device 332 can transmit analog signals representative of discrete and/or analog events to the I/O system 312 without using a network communication protocol such as TCP/IP. In some examples, the seventh field device 332 can transmit data to the I/O system 312 via a bus protocol (e.g., CAN bus, J1939 bus, Profibus, Modbus, etc.).

The I/O system 312 of the illustrated example includes one or more I/O cards that are in communication with the controller 314 via a network communication protocol. For example, the seventh field device 332 can transmit data representative of a sensor measurement to the I/O system 312 using Profibus. The I/O system 312 can transmit the received data to the controller 314 using Ethernet.

Portion(s) of the third process control system 300 is/are time synchronized. For example, the fifth field device 306, the sixth field device 308, the network switch 310, and/or the I/O system 312 can be time synchronized with one(s) of each other. The seventh field device 332 may not be time synchronized with other portion(s) of the third process control system 300 because the seventh field device 332 is a non-network-based field device. For example, the seventh field device 332 may rely on the I/O system 312 to be time synchronized with the controller 314. In some examples, the seventh field device 332 does not generate timestamps associated with sensor measurements. For example, the I/O system 312 can generate timestamps to mark times at which sensor measurements are received by the I/O system 312 from the seventh field device 332.

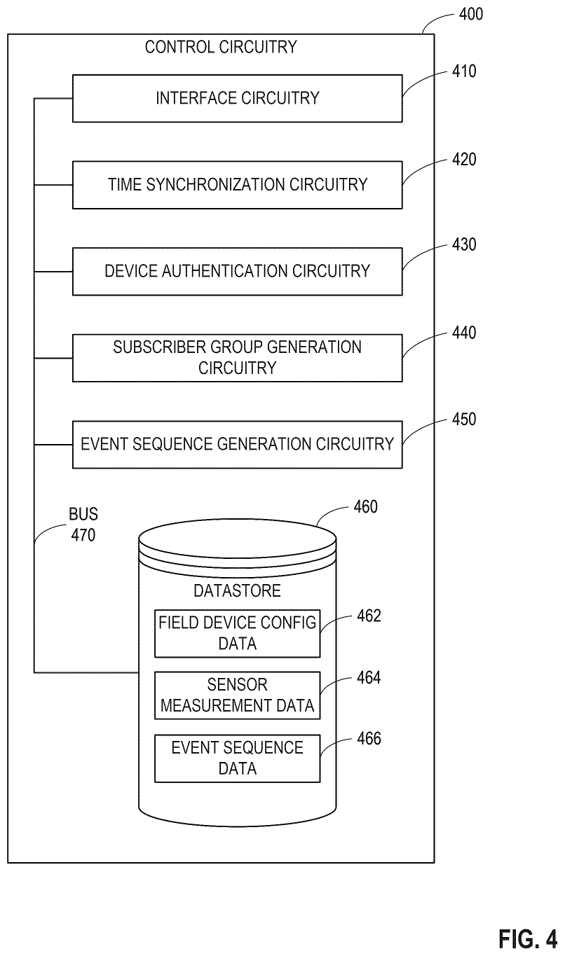

FIG. 4 is a block diagram of example control circuitry 400 to generate sequence(s) of events obtained from field devices. In some examples, the control circuitry 400 can implement the controller 114 of FIG. 1, the controller 214 of FIG. 2, and/or the controller 314 of FIG. 3. The control circuitry 400 of FIG. 4 may be instantiated (e.g., creating an instance of, bring into being for any length of time, materialize, implement, etc.) by processor circuitry such as a central processing unit executing instructions. Additionally or alternatively, the control circuitry 400 of FIG. 4 may be instantiated (e.g., creating an instance of, bring into being for any length of time, materialize, implement, etc.) by an ASIC or an FPGA structured to perform operations corresponding to the instructions. It should be understood that some or all of the control circuitry 400 of FIG. 4 may, thus, be instantiated at the same or different times. Some or all of the control circuitry 400 of FIG. 4 may be instantiated, for example, in one or more threads executing concurrently on hardware and/or in series on hardware. Moreover, in some examples, some or all of the control circuitry 400 of FIG. 4 may be implemented by microprocessor circuitry executing instructions to implement one or more virtual machines and/or containers executing on the microprocessor.

The control circuitry 400 of the illustrated example includes example interface circuitry 410, example time synchronization circuitry 420, example device authentication circuitry 430, example subscriber group generation circuitry 440, example event sequence generation circuitry 450, an example datastore 460, and an example bus 470. In this example. the datastore 460 includes example field device configuration data 462 (identified by FIELD DEVICE CONFIG DATA), example sensor measurement data 464, and example event sequence data 466. In the illustrated example of FIG. 4, the interface circuitry 410, the time synchronization circuitry 420, the device authentication circuitry 430, the subscriber group generation circuitry 440, the event sequence generation circuitry 450, and the datastore 460 are in communication with one(s) of each other via the bus 470. For example, the bus 470 can be implemented by at least one of an Inter-Integrated Circuit (I2C) bus, a Serial Peripheral Interface (SPI) bus, a Peripheral Component Interconnect (PCI) bus, or a Peripheral Component Interconnect Express (PCIe or PCIE) bus. Additionally or alternatively, the bus 470 can be implemented by any other type of computing or electrical bus.

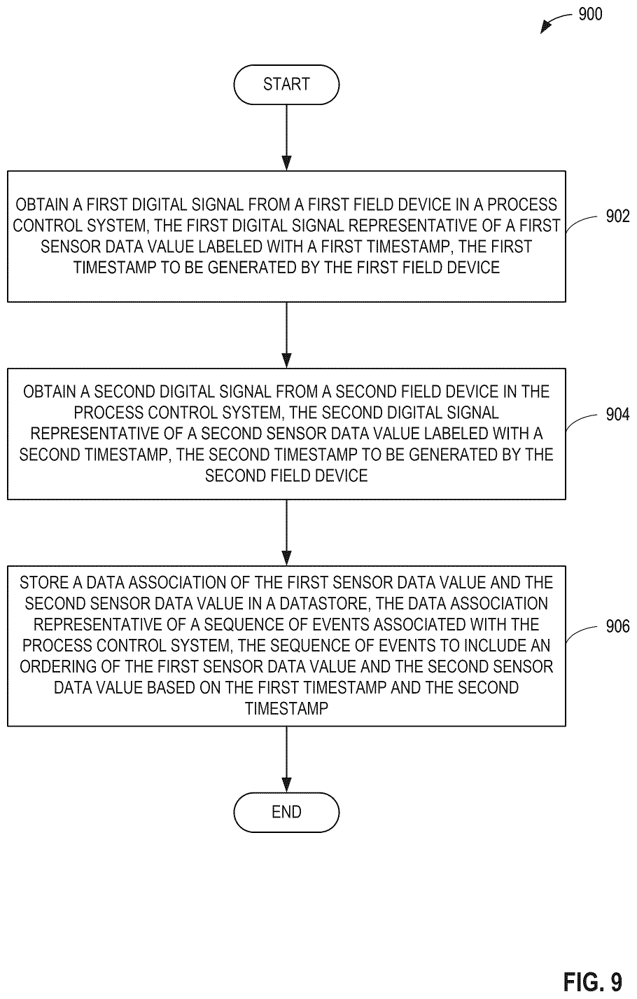

The control circuitry 400 of the illustrated example of FIG. 4 includes the interface circuitry 410 to obtain digital signals from field devices in a process control system. In some examples, the digital signals are signals based on a network communication protocol, such as TCP/IP. For example, the interface circuitry 410 can obtain, receive, etc., digital signals representative of TCP/IP data packets, messages, etc., from field devices, such as the fifth field device 306 and/or the sixth field device 308 of FIG. 3. In some examples, the interface circuitry 410 is instantiated by processor circuitry executing interface instructions and/or configured to perform operations such as those represented by the flowcharts of FIGS. 9, 10, 11, 13, and/or 15. In some examples, the interface circuitry 410 obtains digital signals from field devices in a process control system when a trip condition or event is not identified (e.g., there are no events being generated or occurring in the third process control system 300). For example, the interface circuitry 410 can obtain digital signals from at least one of the fifth field device 306, the sixth field device 308, or the seventh field device 332 on a periodic basis even in the absence of event(s) occurring in the third process control system 300. Advantageously, such collection(s) of digital signals in the absence of events is beneficial when analyzing subsequently occurring events. Advantageously, by analyzing digital signals, which can be representative of sensor measurements, previously obtained during time periods leading up to the subsequently occurring events can be used to identify root cause(s) of the subsequently occurring events.

In some examples, the interface circuitry 410 obtains a first digital signal from a first field device in a process control system, the first digital signal representative of a first sensor data value labeled with a first timestamp, the first timestamp generated by the first field device. For example, the fifth field device 306 can generate a first timestamp associated with a beginning of a measurement period. The fifth field device 306 can obtain a position sensor measurement associated with a position of the fifth valve 322. The fifth field device 306 can generate a second timestamp and label the position sensor measurement with the second timestamp. The fifth field device 306 can generate a first TCP/IP message including the position sensor measurement, the first timestamp, and/or the second timestamp. The fifth field device 306 can transmit the first TCP/IP message to the controller 314 via the network switch 310. For example, the interface circuitry 410 can store the position sensor measurement, the first timestamp, the second timestamp, and/or, more generally, the first TCP/IP message, in the datastore 460 as the sensor measurement data 464.

In some examples, the interface circuitry 410 obtains a second digital signal from a second field device in the process control system, the second digital signal representative of a second sensor data value labeled with a second timestamp, the second timestamp generated by the second field device. For example, the sixth field device 308 can generate a third timestamp associated with a beginning of a measurement period. In some examples, the third timestamp can be the same as the first timestamp because a first clock of the fifth field device 306 can be synchronized with a second clock of the sixth field device 308. The sixth field device 308 can obtain a pressure sensor measurement associated with a fluid pressure of the sixth valve 324. The sixth field device 308 can generate a fourth timestamp and label the pressure sensor measurement with the fourth timestamp. The sixth field device 308 can generate a second TCP/IP message including the pressure sensor measurement, the third timestamp, and/or the fourth timestamp. The sixth field device 308 can transmit the second TCP/IP message to the controller 314 via the network switch 310. For example, the interface circuitry 410 can store the pressure measurement, the third timestamp, the fourth timestamp, and/or, more generally, the second TCP/IP message, in the datastore 460) as the sensor measurement data 464.

In some examples, the interface circuitry 410 obtains a third digital signal from an I/O system, the third digital signal representative of a third sensor data value labeled with a third timestamp, the third timestamp generated by the I/O system. For example, the seventh field device 332 can obtain a pressure sensor measurement associated with a fluid pressure of the seventh valve 336. The seventh field device 332 can transmit an analog signal representative of the pressure sensor measurement to the I/O system 312. The I/O system 312 can generate a fifth timestamp associated with a beginning of a measurement period. In some examples, the fifth timestamp can be the same as the first timestamp and/or the third timestamp because a third clock of the I/O system 312 can be synchronized with the first clock of the fifth field device 306 and/or the second clock of the sixth field device 308. The I/O system 312 can generate a sixth timestamp and label the pressure sensor measurement with the sixth timestamp, which corresponds to the time at which the I/O system 312 received the pressure sensor measurement from the seventh field device 332. The I/O system 312 can generate a third TCP/IP message including the pressure sensor measurement, the fifth timestamp, and/or the sixth timestamp. The I/O system 312 can transmit the third TCP/IP message to the controller 314. For example, the interface circuitry 410 can store the pressure measurement, the fifth timestamp, the sixth timestamp, and/or, more generally, the third TCP/IP message, in the datastore 460) as the sensor measurement data 464.

In some examples, the interface circuitry 410 obtains sensor measurement data from subscribing field device(s) associated with a field device based on an event subscription ID. For example, the fifth field device 306 can be a signaling field device (or a publisher field device) and the sixth field device 308 can be a subscriber field device. In some examples, a signaling field device can be a field device that transmits an event to electronic device(s), such as a field device, a controller, a network switch, an I/O system, etc. In some examples, a subscriber field device can be a field device that is associated with a signaling field device. For example, the signaling field device and the subscriber field device can be field devices in the same process, operation, etc., in a process control system. For example, the signaling field device can be a field device that obtains pressure measurements associated with a valve and the subscriber field device can be a field device that controls a safety or emergency shutdown system associated with the valve. In some examples, the signaling field device and the subscriber field device can be associated with each other based on an event subscription ID. For example, the event subscription ID can be an alphanumerical data value stored in at least one of the controller 314, the network switch 310, the fifth field device 306, the sixth field device 308, or the I/O system 312. In some examples, the interface circuitry 410 can obtain sensor measurement data from the sixth field device 308, which can be a subscriber field device to the fifth field device 306, in response to a signaling field device such as the fifth field device 306 generating and/or transmitting an event.

In some examples, the interface circuitry 410 determines whether to continue monitoring a process control system. For example, the interface circuitry 410 can determine whether to continue obtaining events from at least one of the fifth field device 306, the sixth field device 308, or the I/O system 312.

The control circuitry 400 of the illustrated example of FIG. 4 includes the time synchronization circuitry 420 to synchronize electronic device clocks in a process control system. For example, the fifth field device 306 can have a first clock (e.g., a clock generator, a processor clock, a processor clock generator, etc.), the sixth field device 308 can have a second clock, the I/O system 312 can have a third clock, and the controller 314 can have a fourth clock. In some examples, the time synchronization circuitry 420 can synchronize the first clock, the second clock, the third clock, and/or the fourth clock with one(s) of each other. For example, the time synchronization circuitry 420 can utilize any synchronization schema or time protocol, such as Network Time Protocol (NTP), Highway Addressable Remote Transducer (HART) protocol, etc. In some examples, the time synchronization circuitry 420 is instantiated by processor circuitry executing time synchronization instructions and/or configured to perform operations such as those represented by the flow charts of FIGS. 9, 10, 11, 13, and/or 15.

The control circuitry 400 of the illustrated example of FIG. 4 includes the device authentication circuitry 430 to authenticate a field device. In some examples, the device authentication circuitry 430 can authenticate a field device to join a process control system. For example, the device authentication circuitry 430 can authenticate and/or otherwise grant access to the fifth field device 306, the sixth field device 308, and/or the I/O system 312 to join the third process control system 300. In some examples, the device authentication circuitry 430 can authenticate a field device based on a security or encryption technique, such as a symmetric key encryption technique, an asymmetric key encryption technique, etc., and/or any combination(s) thereof. For example, the device authentication circuitry 430 can authenticate the fifth field device 306, the sixth field device 308, and/or the I/O system 312 via an Advanced Encryption Standard (AES) technique, a Rivest-Shamir-Adleman (RSA) encryption technique, a Triple Data Encryption Standard (DES) technique, etc., and/or any combination(s) thereof. In some examples, the device authentication circuitry 430 is instantiated by processor circuitry executing device authentication instructions and/or configured to perform operations such as those represented by the flowcharts of FIGS. 9, 10, 11, 13, and/or 15.

The control circuitry 400 of the illustrated example of FIG. 4 includes the subscriber group generation circuitry 440 to generate a subscriber group (e.g., a field device subscriber group, an electronic device subscriber group, etc.) based on a publisher/subscriber model. In some examples, the subscriber group generation circuitry 440 selects a field device in a process control system to process. For example, the subscriber group generation circuitry 440 can select the fifth field device 306 to process, such as determining whether the fifth field device 306 is to be a subscriber field device to other field device(s) in the third process control system 300. In some examples, the subscriber group generation circuitry 440 is instantiated by processor circuitry executing subscriber group generation instructions and/or configured to perform operations such as those represented by the flowcharts of FIGS. 9, 10, 11, 13, and/or 15.

In some examples, the subscriber group generation circuitry 440 determines whether a field device is associated with other field device(s). For example, the subscriber group generation circuitry 440 can determine that the fifth field device 306 is associated with the sixth field device 308. In some examples, the subscriber group generation circuitry 440) can determine that the fifth field device 306 is associated with the sixth field device 308 based on a process control plan, schematic, configuration, etc., that identifies the fifth field device 306 and the sixth field device 308 as belonging in the same process, operation, etc., of the third process control system 300. For example, the subscriber group generation circuitry 440 can identify the fifth field device 306 as a subscriber field device and the sixth field device 308 as a publisher field device (e.g., the fifth field device 306 to subscribe to events published by the sixth field device 308).

In some examples, the subscriber group generation circuitry 440 generates an event subscription ID to identify a field device as a subscriber to other field device(s). For example, the subscriber group generation circuitry 440 can generate an event subscription ID representative of the fifth field device 306 as being a subscriber field device to the sixth field device 308. In some examples, the subscriber group generation circuitry 440) can generate the event subscription ID as a randomly generated alphanumerical value. In some examples, the subscriber group generation circuitry 440 can generate the event subscription ID based on data associated with the fifth field device 306 and/or the sixth field device 308. For example, the subscriber group generation circuitry 440 can generate the event subscription ID based on providing respective MAC addresses, IP addresses, field device identifiers, etc., as inputs to a cryptographic hash function to generate a hash output, which can be the event subscription ID. In some examples, the subscriber group generation circuitry 440 can generate the event subscription ID as a concatenation of data values, such as a concatenation of a first MAC address (or portion of the first MAC address) of the fifth field device 306 and a second MAC address (or portion of the second MAC address) of the sixth field device 308.

In some examples, the subscriber group generation circuitry 440 determines whether to select another field device in a process control system to process. For example, the subscriber group generation circuitry 440) can determine to select the sixth field device 308 to process, such as determining whether the sixth field device 308 is to be a subscriber field device to other field device(s) in the third process control system 300.

In some examples, the subscriber group generation circuitry 440 transmits configuration data including an event subscription ID to field device(s), the event subscription ID to identify field device(s) as subscriber(s) to other field device(s). For example, the subscriber group generation circuitry 440 can generate an event subscription ID that associates the fifth field device 306 and the sixth field device 308. In some examples, the subscriber group generation circuitry 440) can store configuration data including the event subscription ID in at least one of the controller 314, the network switch 310, the I/O system 312, the fifth field device 306, or the sixth field device 308. In some examples, the subscriber group generation circuitry 440 can store event subscription ID, and/or, more generally, the configuration data, in the datastore 460 as the field device configuration data 462.

In some examples, the subscriber group generation circuitry 440) determines whether a field device broadcasted an event including the event subscription ID. For example, the subscriber group generation circuitry 440) can determine that the fifth field device 306 generated an event including the event subscription ID, which identifies the sixth field device 308 as a subscriber field device to the fifth field device 306.

The control circuitry 400 of the illustrated example of FIG. 4 includes the event sequence generation circuitry 450) to generate a sequence of events associated with a process control system. In some examples, the event sequence generation circuitry 450 stores a data association of a first sensor data value and a second sensor data value in a datastore, the data association representative of a sequence of events associated with a process control system, and the sequence of events including an ordering of the first sensor data value and the second sensor data value based on a first timestamp of the first sensor data value and a second timestamp of the second sensor data value. For example, the event sequence generation circuitry 450) can obtain a first event including a first sensor data measurement and first timestamp(s) from the fifth field device 306. In some examples, the event sequence generation circuitry 450) can obtain a second event including a second sensor data measurement and second timestamp(s) from the sixth field device 308. In some examples, the event sequence generation circuitry 450 can generate a sequence of events including an ordering of the first event and the second event based on a chronological ordering of the first timestamp(s) and the second timestamp(s). In some examples, the event sequence generation circuitry 450) can generate a plot, a graph, a timeline, etc., or any other type of data structure or representation of the sequence of events based on the first event and the second event. For example, the event sequence generation circuitry 450 can store the sequence of events in the datastore 460 as the event sequence data 466. In some examples, the event sequence generation circuitry 450 is instantiated by processor circuitry executing event sequence generation instructions and/or configured to perform operations such as those represented by the flowcharts of FIGS. 9, 10, 11, 13, and/or 15.

In some examples, the event sequence generation circuitry 450) analyzes digital signals that are not associated with an event. For example, the interface circuitry 410 can obtain a first digital signal representative of a first sensor data value from the fifth field device 306 and a second digital signal representative of a second sensor data value from the sixth field device 308. In some such examples, the first and second digital signals are not associated with an event. In some examples, the event sequence generation circuitry 450 can determine that at least one of the first sensor data value or the second sensor data value are indicative of an anomalous condition associated with at least one of the fifth field device 306 or the sixth field device 308. For example, the event sequence generation circuitry 450) can compare the first sensor data value to a baseline sensor data value: determine that the first sensor data value deviates from the baseline sensor data value by a threshold amount: and identify the first sensor data value as being indicative of an anomalous, abnormal, irregular, and/or otherwise atypical condition of the fifth field device 306, and/or, more generally, the fifth fluid flow control assembly 302.

In some examples, after the identification of the anomalous condition, the event sequence generation circuitry 450 can generate and/or store a data association of metadata and the first sensor data value (and/or the second sensor data value) in the datastore 460 as the sensor measurement data 464 and/or the event sequence data 466. For example, the event sequence generation circuitry 450 can generate the metadata to identify the at least one of the first sensor data value or the second sensor data value as associated with the anomalous condition. In some examples, the metadata can be a tag (e.g., a data tag) or any other type of data descriptor. Advantageously, the event sequence generation circuitry 450) can identify the at least one of the first sensor data value or the second sensor data value for subsequent analysis or review. For example, after an event in connection with the fifth field device 306 is identified, the event sequence generation circuitry 450 can identify, based on the metadata, the at least one of the first sensor data value or the second sensor data value to identify potential cause(s) of the event.

The control circuitry 400 of the illustrated example of FIG. 4 includes the datastore 460) to record data, such as the field device configuration data 462, the sensor measurement data 464, and the event sequence data 466. The datastore 460 can be implemented by a volatile memory (e.g., a Synchronous Dynamic Random Access Memory (SDRAM), Dynamic Random Access Memory (DRAM), RAMBUS Dynamic Random Access Memory (RDRAM), etc.) and/or a non-volatile memory (e.g., flash memory). The datastore 460 may additionally or alternatively be implemented by one or more double data rate (DDR) memories, such as DDR, DDR2, DDR3, DDR4, DDR5, mobile DDR (mDDR), DDR SDRAM, etc. The datastore 460 may additionally or alternatively be implemented by one or more mass storage devices such as hard disk drive(s) (HDD(s)), compact disk (CD) drive(s), digital versatile disk (DVD) drive(s), solid-state disk (SSD) drive(s), Secure Digital (SD) card(s), CompactFlash (CF) card(s), etc. While in the illustrated example the datastore 460 is illustrated as a single datastore, the datastore 460 may be implemented by any number and/or type(s) of datastores. Furthermore, the data stored in the datastore 460 may be in any data format such as, for example, binary data, comma delimited data, tab delimited data. structured query language (SQL) structures, etc.

The datastore 460 of the illustrated example includes the field device configuration data 462. In some examples, the field device configuration data 462 can be data for configuring an electronic device in a process control system, such as the controller 314, the I/O system 312, the network switch 310, the fifth field device 306, the sixth field device 308, the seventh field device 332, etc. For example, the field device configuration data 462 can configure the fifth field device 306 to obtain measurements from a sensor of the fifth fluid flow control assembly 302 at a specified sampling rate, transmit the measurements to the controller 314 at a specified transmission rate, etc. In some examples, the field device configuration data 462 can configure one(s) of the field devices 306, 308, 332 to be a subscriber field device or a publisher/signaling field device. For example, the field device configuration data 462 can configure the fifth field device 306 to be a publisher field device, a subscriber field device to the sixth field device 308 and/or the seventh field device 332 (e.g., the seventh field device 332 via the I/O system 312), etc., and/or any combination(s) thereof.

The datastore 460 of the illustrated example includes the sensor measurement data 464 to effectuate generation of sequences of events of a process control system, such as the third process control system 300. In some examples, the sensor measurement data 464 can include data packets, messages, etc., which can include sensor measurements, timestamps, etc. In some examples, the sensor measurement data 464 can include values of process parameters, such as a pressure value (e.g., 50 PSI, 100 PSI, 500 PSI, etc.), a fluid flow rate value (e.g., 5 cubic meters per minute, 10 barrels per minute, etc.). a temperature value (e.g., 30 degrees Celsius, 85 degrees Fahrenheit, etc.), etc. In some examples, the sensor measurement data 464 can include analog signal values corresponding to values of process parameters, such as a value of a current or voltage signal.

The datastore 460 of the illustrated example includes the event sequence data 466 to effectuate diagnostic activities and/or carry out process control safety protocols. For example, the event sequence data 466 can include a plurality of events arranged in sequence based on their respective timestamps. Advantageously, personnel associated with a process control system, such as an engineer, a maintenance technician, a safety coordinator, etc., can inspect event sequences based on the event sequence data 466 to identify root cause(s) of an event, a failure, an unforeseen or unexpected result or outcome, etc. Advantageously, the personnel can carry out mitigation measures, repair efforts, etc., to resolve the root cause(s) and/or prevent them from occurring again.

In some examples, the datastore 460) can implement one or more databases, which can store the field device configuration data 462, the sensor measurement data 464, and/or the event sequence data 466. The term “database” as used herein means an organized body of related data, regardless of the manner in which the data or the organized body thereof is represented. For example, the organized body of related data can be in the form of one or more of a table, a map, a grid, a packet, a datagram, a frame, a file, an e-mail, a message, a document, a report, a list or in any other form. The term “data” as used herein means any indicia, signals, marks, symbols, domains, symbol sets, representations, and any other physical form or forms representing information, whether permanent or temporary. whether visible, audible, acoustic, electric, magnetic, electromagnetic or otherwise manifested. The term “data” as used to represent predetermined information in one physical form shall be deemed to encompass any and all representations of corresponding information in a different physical form or forms.

While an example manner of implementing the controller 114 of FIG. 1. the controller 214 of FIG. 2, and/or the controller 314 of FIG. 3 is illustrated in FIG. 4, one or more of the elements, processes, and/or devices illustrated in FIG. 4 may be combined. divided, re-arranged, omitted, eliminated, and/or implemented in any other way. Further, the interface circuitry 410, the time synchronization circuitry 420, the device authentication circuitry 430, the subscriber group generation circuitry 440, the event sequence generation circuitry 450, the datastore 460, the bus 470, and/or, more generally, the controller 114 of FIG. 1, the controller 214 of FIG. 2, and/or the controller 314 of FIG. 3, may be implemented by hardware alone or by hardware in combination with software and/or firmware. Thus, for example, any of the interface circuitry 410, the time synchronization circuitry 420, the device authentication circuitry 430, the subscriber group generation circuitry 440, the event sequence generation circuitry 450, the datastore 460, the bus 470, and/or, more generally, the example the controller 114 of FIG. 1, the controller 214 of FIG. 2, and/or the controller 314 of FIG. 3, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). Further still, the example the controller 114 of FIG. 1, the controller 214 of FIG. 2, and/or the controller 314 of FIG. 3 may include one or more elements, processes, and/or devices in addition to, or instead of, those illustrated in FIG. 4, and/or may include more than one of any or all of the illustrated elements, processes and devices.

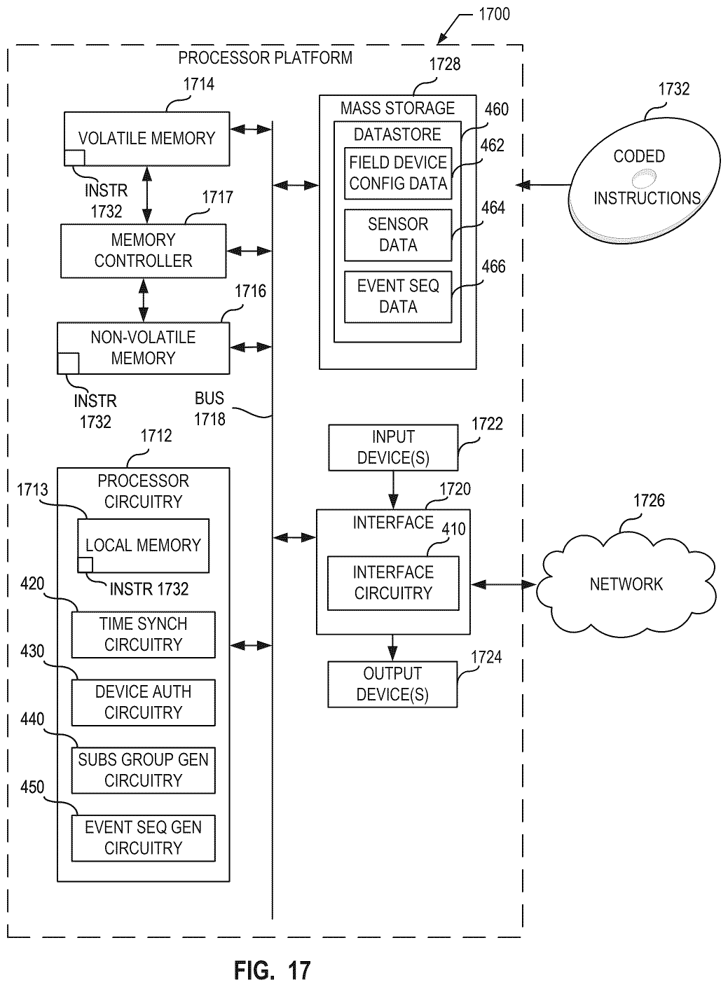

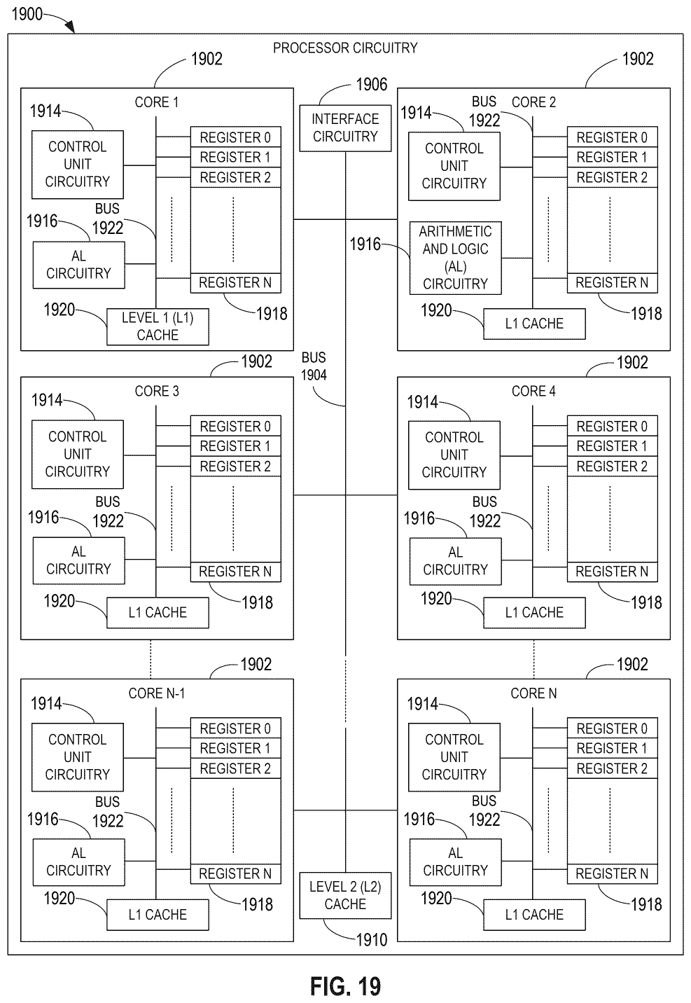

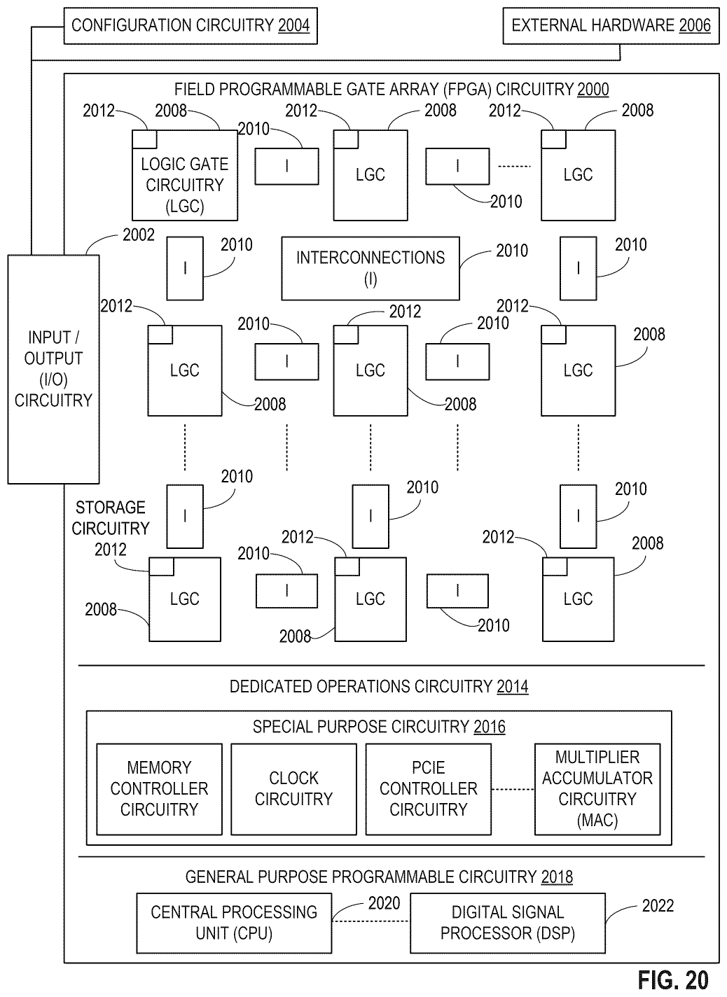

In some examples, the control circuitry 400 includes means for obtaining a digital signal from a field device. For example, the means for obtaining may be implemented by the interface circuitry 410. In some examples, the interface circuitry 410 may be instantiated by processor circuitry such as the example processor circuitry 1712 of FIG. 17. For instance, the interface circuitry 410 may be instantiated by the example microprocessor 1900 of FIG. 19 executing machine executable instructions such as those implemented by at least blocks 902, 904, 1006, 1008, 1010, 1116, 1120, 1302, 1318, 1322, 1502, 1514, 1518 of FIGS. 9, 10, 11, 13, and/or 15. In some examples, the interface circuitry 410 may be instantiated by hardware logic circuitry, which may be implemented by an ASIC, XPU, or the FPGA circuitry 2000 of FIG. 20 structured to perform operations corresponding to the machine readable instructions. Additionally or alternatively, the interface circuitry 410 may be instantiated by any other combination of hardware, software, and/or firmware. For example, the interface circuitry 410 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.), a gateway, a switch, a transmitter, a receiver, a transceiver, etc., structured to execute some or all of the machine readable instructions and/or to perform some or all of the operations corresponding to the machine readable instructions without executing software or firmware, but other structures are likewise appropriate.

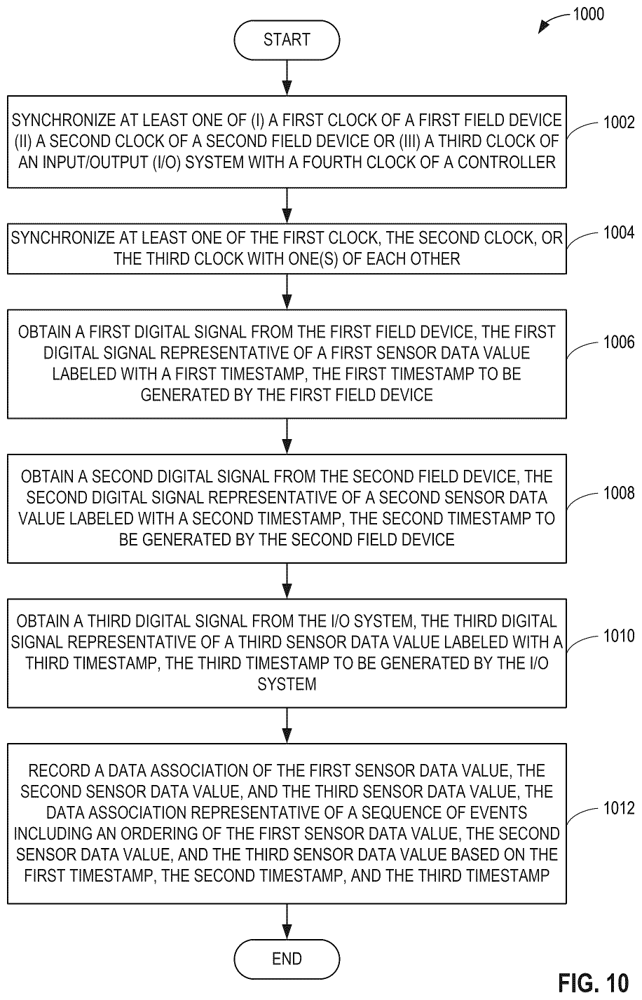

In some examples, the control circuitry 400 includes means for synchronizing clocks associated with field devices. For example, the means for synchronizing may be implemented by the time synchronization circuitry 420. In some examples, the time synchronization circuitry 420 may be instantiated by processor circuitry such as the example processor circuitry 1712 of FIG. 17. For instance, the time synchronization circuitry 420 may be instantiated by the example microprocessor 1900 of FIG. 19 executing machine executable instructions such as those implemented by at least blocks 1002, 1004 of FIG. 10. In some examples, the time synchronization circuitry 420 may be instantiated by hardware logic circuitry, which may be implemented by an ASIC, XPU, or the FPGA circuitry 2000 of FIG. 20) structured to perform operations corresponding to the machine readable instructions. Additionally or alternatively, the time synchronization circuitry 420 may be instantiated by any other combination of hardware, software, and/or firmware. For example, the time synchronization circuitry 420 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

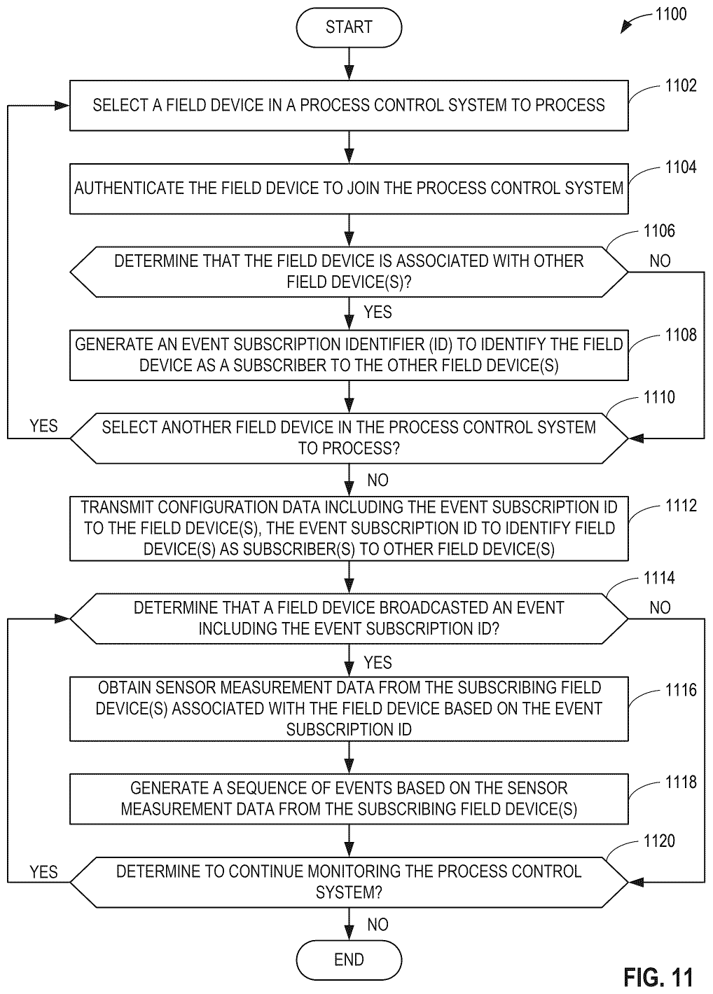

In some examples, the control circuitry 400 includes means for authenticating a field device to join a process control system. For example, the means for authenticating may be implemented by the device authentication circuitry 430. In some examples, the device authentication circuitry 430 may be instantiated by processor circuitry such as the example processor circuitry 1712 of FIG. 17. For instance, the device authentication circuitry 430 may be instantiated by the example microprocessor 1900 of FIG. 19 executing machine executable instructions such as those implemented by at least block 1104 of FIG. 11. In some examples, the device authentication circuitry 430 may be instantiated by hardware logic circuitry, which may be implemented by an ASIC, XPU, or the FPGA circuitry 2000 of FIG. 20 structured to perform operations corresponding to the machine readable instructions. Additionally or alternatively, the device authentication circuitry 430 may be instantiated by any other combination of hardware, software, and/or firmware. For example, the device authentication circuitry 430 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the control circuitry 400 includes means for creating and/or establishing a subscriber group of field devices and/or I/O systems associated with a process control system. For example, the means for creating and/or establishing may be implemented by the subscriber group generation circuitry 440. In some examples, the subscriber group generation circuitry 440 may be instantiated by processor circuitry such as the example processor circuitry 1712 of FIG. 17. For instance, the subscriber group generation circuitry 440) may be instantiated by the example microprocessor 1900 of FIG. 19 executing machine executable instructions such as those implemented by at least blocks 1106, 1108, 1110, 1112, 1114 of FIG. 11. In some examples, the subscriber group generation circuitry 440 may be instantiated by hardware logic circuitry, which may be implemented by an ASIC, XPU, or the FPGA circuitry 2000 of FIG. 20 structured to perform operations corresponding to the machine readable instructions. Additionally or alternatively, the subscriber group generation circuitry 440 may be instantiated by any other combination of hardware, software, and/or firmware. For example, the subscriber group generation circuitry 440 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the control circuitry 400 includes means for generating a sequence of events. For example, the means for generating may be implemented by the event sequence generation circuitry 450. In some examples, the event sequence generation circuitry 450 may be instantiated by processor circuitry such as the example processor circuitry 1712 of FIG. 17. For instance, the event sequence generation circuitry 450 may be instantiated by the example microprocessor 1900 of FIG. 19 executing machine executable instructions such as those implemented by at least blocks 906, 1012, 1118, 1302. 1318. 1322, 1502, 1514, 1518 of FIGS. 9, 10, 11, 13, and/or 15. In some examples, the subscriber group generation circuitry 440 may be instantiated by hardware logic circuitry. which may be implemented by an ASIC, XPU, or the FPGA circuitry 2000 of FIG. 20 structured to perform operations corresponding to the machine readable instructions. Additionally or alternatively, the event sequence generation circuitry 450) may be instantiated by any other combination of hardware, software, and/or firmware. For example, the event sequence generation circuitry 450 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the control circuitry 400 includes means for storing data. For example, the means for storing may be implemented by the datastore 460. In some examples, the means for storing may be instantiated by processor circuitry such as the example processor circuitry 1712 of FIG. 17. For instance, the datastore 460 may be instantiated by the example microprocessor 1900 of FIG. 19 executing machine executable instructions such as those implemented by at least blocks 906, 1012, 1118 of FIGS. 9, 10, and/or 11. In some examples, the datastore 460 may be instantiated by hardware logic circuitry, which may be implemented by an ASIC, XPU, or the FPGA circuitry 2000 of FIG. 20) structured to perform operations corresponding to the machine readable instructions. Additionally or alternatively, the datastore 460 may be instantiated by any other combination of hardware, software, and/or firmware. For example, the datastore 460) may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

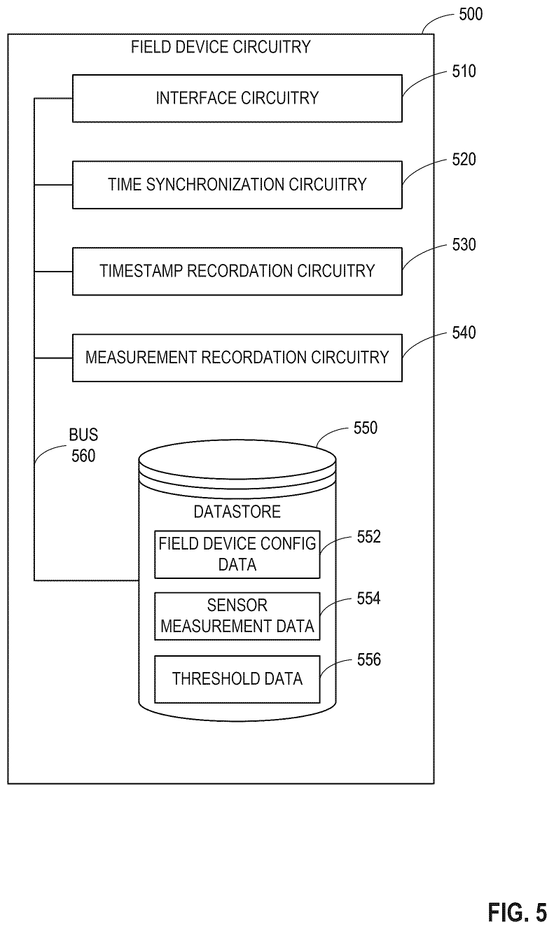

FIG. 5 is a block diagram of field device circuitry 500 to generate events to effectuate event sequence generation associated with a process control system. In some examples, the field device circuitry 500 can implement the third field device 206, the fourth field device 208, the fifth field device 306, the sixth field device 308, and/or the seventh field device 332. In some examples, the field device circuitry 500 can implement the I/O system 312. The field device circuitry 500 of FIG. 5 may be instantiated (e.g., creating an instance of, bring into being for any length of time, materialize, implement, etc.) by processor circuitry such as a central processing unit executing instructions. Additionally or alternatively, the field device circuitry 500 of FIG. 5 may be instantiated (e.g., creating an instance of, bring into being for any length of time, materialize, implement, etc.) by an ASIC or an FPGA structured to perform operations corresponding to the instructions. It should be understood that some or all of the field device circuitry 500 of FIG. 5 may, thus, be instantiated at the same or different times. Some or all of the field device circuitry 500 of FIG. 5 may be instantiated, for example, in one or more threads executing concurrently on hardware and/or in series on hardware. Moreover, in some examples, some or all of the field device circuitry 500 of FIG. 5 may be implemented by microprocessor circuitry executing instructions to implement one or more virtual machines and/or containers executing on the microprocessor.

The field device circuitry 500 of the illustrated example of FIG. 5 includes example interface circuitry 510, example time synchronization circuitry 520, example timestamp recordation circuitry 530, example measurement recordation circuitry 540, an example datastore 550, and an example bus 560. In this example, the datastore 550 includes example field device configuration data 552, example sensor measurement data 554, and example threshold data 556. In the illustrated example of FIG. 5, the interface circuitry 510, the time synchronization circuitry 520, the timestamp recordation circuitry 530, the measurement recordation circuitry 540, and the datastore 550 are in communication with one(s) of each other via the bus 560. For example, the bus 560 can be implemented by at least one of an I2C bus, a SPI bus, a PCI bus, or a PCIe or PCIE bus. Additionally or alternatively, the bus 560 can be implemented by any other type of computing or electrical bus.

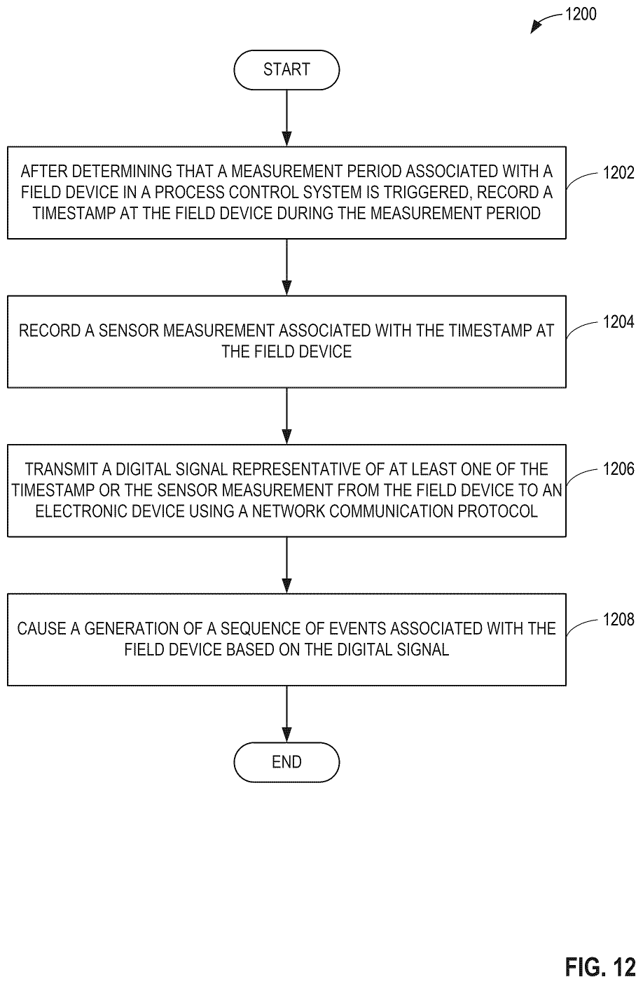

The field device circuitry 500 of the illustrated example of FIG. 5 includes the interface circuitry 510 to transmit data to and/or receive data from an electronic device, such as one(s) of the field devices 306, 308, 332, the network switch 310, the controller 314, and/or the I/O system 312. In some examples, the interface circuitry 510 transmits data including a timestamp and a digital value from a field device, such as the fifth field device 306, to an electronic device, such as the controller 314 (e.g., via the network switch 310), using a network communication protocol, such as TCP/IP. In some examples, the interface circuitry 510 causes a generation of a sequence of events associated with a field device based on the data. For example, in response to transmitting the timestamp and the digital value to the controller 314, the controller 314 can generate a sequence of events associated with the fifth field device 306 based on (i) a digital value associated with a sensor measurement of the fifth field device 306 and (ii) a timestamp associated with the sensor measurement. In some examples, the interface circuitry 510 is instantiated by processor circuitry executing interface instructions and/or configured to perform operations such as those represented by the flowcharts of FIGS. 12, 13, 14, 15, and/or 16.

In some examples, the interface circuitry 510 transmits sensor measurement data, such as minimum and/or maximum values of the sensor measurement data, to the controller 314. For example, the interface circuitry 510 can cause the controller 314 to generate a sequence of events associated with the fifth field device 306 by transmitting the minimum and/or maximum values of the sensor measurement from the fifth field device 306 to the controller 314.

In some examples, the interface circuitry 510 publishes and/or otherwise broadcasts event (e.g., event data) to electronic device(s) in a process control system. For example, the interface circuitry 510 can determine, based on the field device configuration data 552, that the sixth field device 308 is a subscriber (e.g., a data subscriber, an event subscriber, etc.) to the fifth field device 306. In some examples, the interface circuitry 510 can generate an event, which can include sensor measurement data, associated timestamp(s), an event subscription identifier that identifies the sixth field device 308 as a subscriber to the fifth field device 306, etc. In some examples, the interface circuitry 510 can broadcast the event to subscribing field device(s), such as the sixth field device 308, and/or the controller 314 via the network switch 310.

The field device circuitry 500 of the illustrated example of FIG. 5 includes the time synchronization circuitry 520 to synchronize electronic device clocks in a process control system. For example, the fifth field device 306 can have a first clock (e.g., a clock generator, a processor clock, a processor clock generator, etc.), the sixth field device 308 can have a second clock, the I/O system 312 can have a third clock, and the controller 314 can have a fourth clock. In some examples, the time synchronization circuitry 520 can synchronize the first clock, the second clock, the third clock, and/or the fourth clock with one(s) of each other. For example, the time synchronization circuitry 520 can utilize any synchronization schema or time protocol, such as Network Time Protocol (NTP), Highway Addressable Remote Transducer (HART) protocol, etc. In some examples, the time synchronization circuitry 520 is instantiated by processor circuitry executing time synchronization instructions and/or configured to perform operations such as those represented by the flowcharts of FIGS. 12, 13, 14, 15, and/or 16.

The field device circuitry 500 of the illustrated example of FIG. 5 includes the timestamp recordation circuitry 530 to record a timestamp associated with a time at which an event is observed, identified, and/or otherwise detected by an electronic device. In some examples, the timestamp recordation circuitry 530 can annotate, label, mark, and/or otherwise associate a sensor measurement, a signal value, etc., with a timestamp determined by a clock (e.g., a clock generator) of an electronic device that measured the sensor measurement, the signal value, etc. In some examples, the timestamp recordation circuitry 530 is instantiated by processor circuitry executing timestamp recordation instructions and/or configured to perform operations such as those represented by the flowcharts of FIGS. 12, 13, 14, 15, and/or 16.

In some examples, the timestamp recordation circuitry 530 can record a first timestamp at a field device at a beginning of a measurement period. In some examples, the timestamp recordation circuitry 530 can record a second timestamp at the field device during the measurement period. In some examples, the timestamp recordation circuitry 530 can record a third timestamp at the field device at the end or conclusion of the measurement period.

The field device circuitry 500 of the illustrated example of FIG. 5 includes the measurement recordation circuitry 540 to measure and/or otherwise obtain a measurement (e.g., a data measurement, a sensor measurement, etc.) from a sensor in a process control system. In some examples, the measurement recordation circuitry 540 records a digital value based on a sensor measurement associated with a timestamp at a field device. For example, the measurement recordation circuitry 540 can obtain an analog signal value of 8 mA from a sensor of the fifth fluid flow control assembly 302. In some examples, the measurement recordation circuitry 540 can convert the analog signal value of 8 mA to a binary value, a hexadecimal value, etc. Alternatively, the measurement recordation circuitry 540 may convert a value of a parameter that corresponds to the 8 mA, such as a pressure measurement value of 500 PSI, into a corresponding binary value, hexadecimal value, etc. In some examples, the measurement recordation circuitry 540 can encode the binary value, the hexadecimal value, etc., into a digital signal that can be transmitted to an electronic device, such as the controller 314, using TCP/IP. In some examples, the measurement recordation circuitry 540 is instantiated by processor circuitry executing measurement recordation instructions and/or configured to perform operations such as those represented by the flowcharts of FIGS. 12, 13, 14, 15, and/or 16.

In some examples, the measurement recordation circuitry 540 determines whether a measurement period associated with a field device is triggered. For example, the measurement recordation circuitry 540 can determine that the fifth field device 306 is configured (e.g., based on the field device configuration data 552) to obtain sensor measurements from a sensor every 10 ms. In some example, the measurement recordation circuitry 540 can determine that the measurement period is triggered based on a determination that 10 ms has elapsed since the previous measurement period. In some examples, the measurement recordation circuitry 540 can record a minimum value and/or a maximum value of a sensor measurement during a measurement period (e.g., between a first timestamp at a beginning of the measurement period and a second timestamp at an end of the measurement period).

In some examples, the measurement recordation circuitry 540 obtains sensor measurement(s) at a beginning of a measurement period, during the measurement period, and/or at an end of the measurement period. For example, the measurement recordation circuitry 540 can record a first digital value based on a first sensor measurement at a beginning of a measurement period, a second digital value based on a second sensor measurement during the measurement period, and/or a third digital value based on a third sensor measurement at an end of the measurement period.

In some examples, the measurement recordation circuitry 540 determines whether a sensor measurement satisfies a threshold. For example, the measurement recordation circuitry 540 can compare a pressure sensor measurement of 500 PSI to a threshold (e.g., a data threshold, a pressure threshold, etc.) of 1000 PSI. In some examples, the measurement recordation circuitry 540 can determine that the pressure sensor measurement of 500 PSI does not satisfy the threshold of 1000 PSI because 500 PSI is less than 1000 PSI. In some examples, the measurement recordation circuitry 540 can determine that a pressure sensor measurement of 1500 PSI satisfies the threshold of 500 PSI because 1500 PSI is greater than 500 PSI.

In some examples, the measurement recordation circuitry 540 can determine that a sensor measurement satisfies a threshold because the sensor measurement is less than the threshold. For example, the measurement recordation circuitry 540 can determine that a temperature measurement of 15 degrees Celsius satisfies a threshold (e.g., a data threshold, a temperature threshold) of 25 degrees Celsius because 15 degrees Celsius is less than 25 degrees Celsius. In some examples, the measurement recordation circuitry 540 can identify the threshold based on a query of applicable threshold(s) in the threshold data 556. As used herein a “threshold” is expressed as data, such as a numerical value represented in any form, that may be used by processor circuitry as a reference for a comparison operation.

In some examples, the measurement recordation circuitry 540 can determine that a field device is to generate an event. For example, the measurement recordation circuitry 540 can detect a change in a sensor measurement from a sensor of the fifth fluid flow control assembly 302. In some examples, the measurement recordation circuitry 540 can determine that the sensor measurement deviated beyond an expected value, changed by more than a threshold amount, etc. In some examples, the measurement recordation circuitry 540 can determine to generate an event after a determination that a detected change in a sensor measurement is to be broadcasted to portion(s) of a process control system. For example, the measurement recordation circuitry 540 can invoke the interface circuitry 510 to broadcast the event to subscribing field device(s) of the fifth field device 306.

In some examples, the measurement recordation circuitry 540 can determine whether to continue monitoring an electronic device and/or, more generally, a process control system that includes the electronic device. For example, the measurement recordation circuitry 540 can determine to continue monitoring the fifth field device 306 because the field device configuration data 552 indicates that the fifth field device 306 is to publish sensor measurements every 20 ms.

The field device circuitry 500 of the illustrated example of FIG. 5 includes the datastore 550 to record data, such as the field device configuration data 552, the sensor measurement data 554, and the threshold data 556. In some examples, the field device configuration data 552 of FIG. 5 can correspond to the field device configuration data 462 of FIG. 4. In some examples, the sensor measurement data 554 of FIG. 5 can correspond to the sensor measurement data 464 of FIG. 4. In some examples, the threshold data 556 can include one or more thresholds that can be utilized by processor circuitry for comparison operation(s).

The datastore 550 can be implemented by a volatile memory (e.g., an SDRAM, a DRAM, an RDRAM, etc.) and/or a non-volatile memory (e.g., flash memory). The datastore 550 may additionally or alternatively be implemented by one or more DDR memories, such as DDR, DDR2, DDR3, DDR4, DDR5, mDDR, DDR SDRAM, etc. The datastore 550) may additionally or alternatively be implemented by one or more mass storage devices such as HDD(s), CD drive(s), DVD drive(s), SSD drive(s), SD card(s), CF card(s), etc. While in the illustrated example the datastore 550 is illustrated as a single datastore, the datastore 550 may be implemented by any number and/or type(s) of datastores. Furthermore, the data stored in the datastore 550 may be in any data format such as, for example, binary data, comma delimited data, tab delimited data, SQL structures, etc.

While an example manner of implementing the third field device 206 of FIG. 2. the fourth field device 208 of FIG. 2, the fifth field device 306 of FIG. 3, the sixth field device 308 of FIG. 3, the seventh field device 332 of FIG. 3, and/or the I/O system 312 of FIG. 3 is illustrated in FIG. 5, one or more of the elements, processes, and/or devices illustrated in FIG. 5 may be combined, divided, re-arranged, omitted, eliminated, and/or implemented in any other way. Further, the interface circuitry 510, the time synchronization circuitry 520, the timestamp recordation circuitry 530, the measurement recordation circuitry 540, the datastore 550, the bus 560, and/or, more generally, the third field device 206 of FIG. 2. the fourth field device 208 of FIG. 2, the fifth field device 306 of FIG. 3, the sixth field device 308 of FIG. 3, the seventh field device 332 of FIG. 3, and/or the I/O system 312 of FIG. 3, may be implemented by hardware alone or by hardware in combination with software and/or firmware. Thus, for example, any of the interface circuitry 510, the time synchronization circuitry 520, the timestamp recordation circuitry 530, the measurement recordation circuitry 540, the datastore 550, the bus 560, and/or, more generally, the third field device 206 of FIG. 2. the fourth field device 208 of FIG. 2, the fifth field device 306 of FIG. 3, the sixth field device 308 of FIG. 3, the seventh field device 332 of FIG. 3, and/or the I/O system 312 of FIG. 3, could be implemented by processor circuitry, analog circuit(s), digital circuit(s), logic circuit(s), programmable processor(s), programmable microcontroller(s), GPU(s), DSP(s), ASIC(s), PLD(s), and/or FPLD(s) such as FPGAs. Further still, the third field device 206 of FIG. 2, the fourth field device 208 of FIG. 2. the fifth field device 306 of FIG. 3, the sixth field device 308 of FIG. 3, the seventh field device 332 of FIG. 3, and/or the I/O system 312 of FIG. 3 may include one or more elements, processes, and/or devices in addition to, or instead of, those illustrated in FIG. 5, and/or may include more than one of any or all of the illustrated elements, processes and devices.

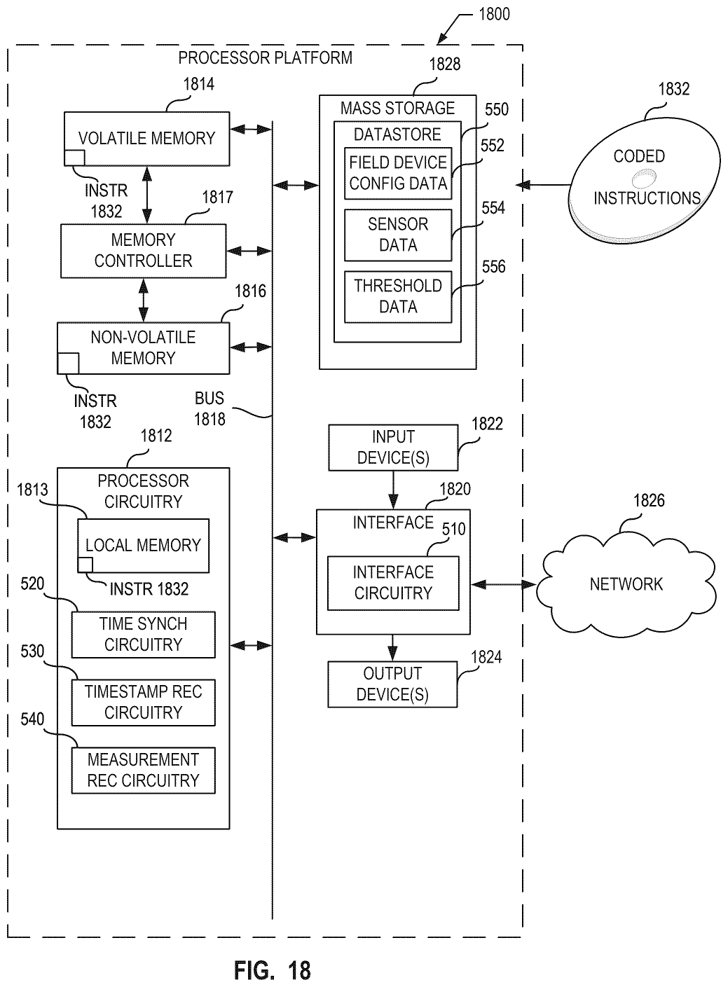

In some examples, the field device circuitry 500 includes means for transmitting a digital signal from a field device and/or means for causing transmission of a digital signal from a field device. For example, the means for transmitting and/or the means for causing may be implemented by the interface circuitry 510. In some examples, the interface circuitry 510 may be instantiated by processor circuitry such as the example processor circuitry 1812 of FIG. 18. For instance, the interface circuitry 510 may be instantiated by the example microprocessor 1900 of FIG. 19 executing machine executable instructions such as those implemented by at least blocks 1206, 1208, 1310, 1316, 1320, 1410, 1418, 1512, 1516, 1604, 1606, 1608, 1610 of FIGS. 12, 13, 14, 15, and/or 16. In some examples. the interface circuitry 510 may be instantiated by hardware logic circuitry, which may be implemented by an ASIC, XPU, or the FPGA circuitry 2000 of FIG. 20 structured to perform operations corresponding to the machine readable instructions. Additionally or alternatively, the interface circuitry 510 may be instantiated by any other combination of hardware, software, and/or firmware. For example, the interface circuitry 510 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.), a gateway, a switch, a transmitter, a receiver, a transceiver, etc., structured to execute some or all of the machine readable instructions and/or to perform some or all of the operations corresponding to the machine readable instructions without executing software or firmware, but other structures are likewise appropriate.

In some examples, the field device circuitry 500 includes means for synchronizing clocks of field devices and/or I/O systems. For example, the means for synchronizing may be implemented by the time synchronization circuitry 520. In some examples, the time synchronization circuitry 520 may be instantiated by processor circuitry such as the example processor circuitry 1812 of FIG. 18. For instance, the time synchronization circuitry 520 may be instantiated by the example microprocessor 1900 of FIG. 19 executing machine executable instructions such as those implemented by at least block 1004 of FIG. 10. In some examples, the time synchronization circuitry 520 may be instantiated by hardware logic circuitry, which may be implemented by an ASIC, XPU, or the FPGA circuitry 2000 of FIG. 20 structured to perform operations corresponding to the machine readable instructions. Additionally or alternatively, the time synchronization circuitry 520 may be instantiated by any other combination of hardware, software, and/or firmware. For example, the time synchronization circuitry 520 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.), a gateway, a switch, a transmitter, a receiver, a transceiver, etc., structured to execute some or all of the machine readable instructions and/or to perform some or all of the operations corresponding to the machine readable instructions without executing software or firmware, but other structures are likewise appropriate.

In some examples, the field device circuitry 500 includes first means for recording and/or means for measuring a timestamp. For example, the first means for recording and/or the first means for measuring may be implemented by the timestamp recordation circuitry 530. In some examples, the timestamp recordation circuitry 530 may be instantiated by processor circuitry such as the example processor circuitry 1812 of FIG. 18. For instance, the timestamp recordation circuitry 530 may be instantiated by the example microprocessor 1900 of FIG. 19 executing machine executable instructions such as those implemented by at least blocks 1202. 1306, 1312 of FIGS. 12 and/or 13. In some examples, the timestamp recordation circuitry 530 may be instantiated by hardware logic circuitry. which may be implemented by an ASIC, XPU, or the FPGA circuitry 2000 of FIG. 20 structured to perform operations corresponding to the machine readable instructions. Additionally or alternatively, the timestamp recordation circuitry 530 may be instantiated by any other combination of hardware, software, and/or firmware. For example, the timestamp recordation circuitry 530 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.), a gateway, a switch, a transmitter, a receiver, a transceiver, etc., structured to execute some or all of the machine readable instructions and/or to perform some or all of the operations corresponding to the machine readable instructions without executing software or firmware, but other structures are likewise appropriate.

In some examples, the field device circuitry 500 includes second means for recording and/or means for sensing a measurement. For example, the second means for recording and/or the means for sensing may be implemented by the measurement recordation circuitry 540. In some examples, the measurement recordation circuitry 540 may be instantiated by processor circuitry such as the example processor circuitry 1812 of FIG. 18. For instance, the measurement recordation circuitry 540 may be instantiated by the example microprocessor 1900 of FIG. 19 executing machine executable instructions such as those implemented by at least blocks 1204, 1304, 1308, 1314, 1402, 1404, 1406, 1408, 1412, 1414, 1416, 1420, 1504, 1506, 1508, 1510, 1602, 1612 of FIGS. 12, 13, 14, 15, and/or 16. In some examples, the measurement recordation circuitry 540 may be instantiated by hardware logic circuitry, which may be implemented by an ASIC, XPU, or the FPGA circuitry 2000 of FIG. 20 structured to perform operations corresponding to the machine readable instructions. Additionally or alternatively, the measurement recordation circuitry 540 may be instantiated by any other combination of hardware, software, and/or firmware. For example, the measurement recordation circuitry 540 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.), a gateway, a switch, a transmitter, a receiver, a transceiver, etc., structured to execute some or all of the machine readable instructions and/or to perform some or all of the operations corresponding to the machine readable instructions without executing software or firmware, but other structures are likewise appropriate.

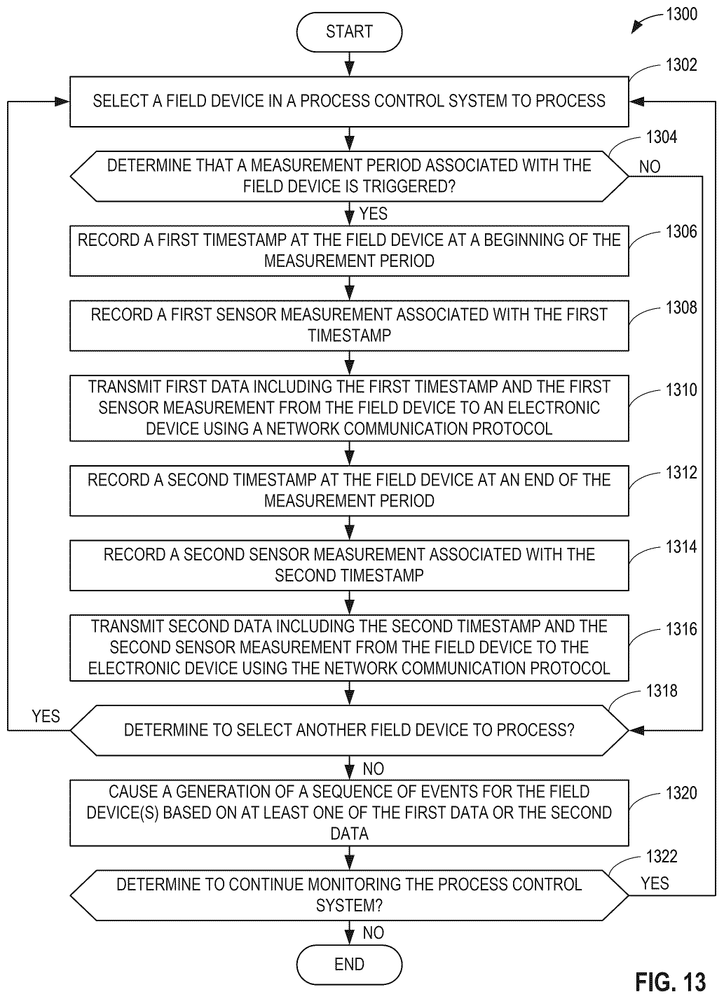

In some examples, the field device circuitry 500 includes means for storing (e.g., second means for storing). For example, the means for storing may be implemented by the datastore 550. In some examples, the datastore 550 may be instantiated by processor circuitry such as the example processor circuitry 1812 of FIG. 18. For instance, the datastore 550) may be instantiated by the example microprocessor 1900 of FIG. 19 executing machine executable instructions such as those implemented by at least blocks 1204, 1306, 1308, 1312, 1314, 1508, 1510 of FIGS. 12, 13, and/or 15. In some examples, the datastore 550 may be instantiated by hardware logic circuitry, which may be implemented by an ASIC. XPU, or the FPGA circuitry 2000 of FIG. 20 structured to perform operations corresponding to the machine readable instructions. Additionally or alternatively, the datastore 550 may be instantiated by any other combination of hardware, software, and/or firmware. For example, the datastore 550) may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.), a gateway, a switch, a transmitter, a receiver, a transceiver, etc., structured to execute some or all of the machine readable instructions and/or to perform some or all of the operations corresponding to the machine readable instructions without executing software or firmware, but other structures are likewise appropriate.

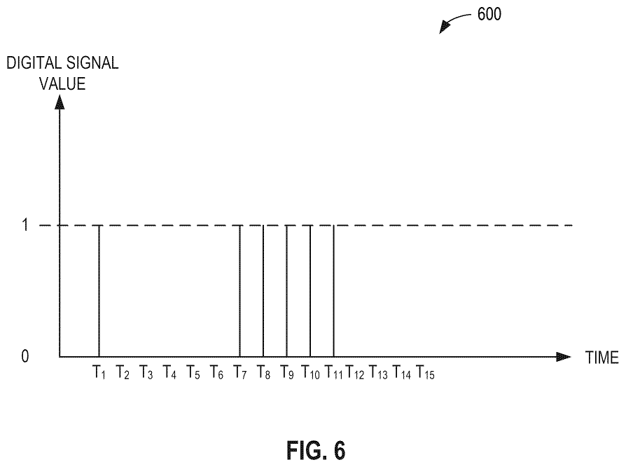

FIG. 6 depicts a first graph 600 of values of example digital signals with respect to time. In some examples, the values of digital signals are generated and/or otherwise outputted by an electronic device, such as the fifth field device 306, the sixth field device 308, the seventh field device 332, and/or the I/O system 312 of FIG. 3. For example, the fifth field device 306 can determine that a digital signal from a position sensor of the fifth fluid flow control assembly 302 is representative of a logic zero (identified by a digital signal value of 0 in the first graph 600) or a logic one (identified by a digital signal value of 1 in the first graph 600).

By way of example, the fifth field device 306 can determine that the fifth valve 322 is closed at a first time (identified by a first timestamp T₁ in the first graph 600) based on a position sensor monitoring the fifth valve 322 outputting a logic one. In some examples, the fifth field device 306 can transmit a first event, which can include a value of the first timestamp T₁ and a first digital signal value representative of a logic one, to the controller 314 via the network switch 310. By way of another example, the fifth field device 306 can determine that the fifth valve 322 is open from a second time (identified by T₂ in the first graph 600) through a sixth time (identified by T₆ in the first graph 600). In some examples, the fifth field device 306 can transmit a second event, which can include a value of the second timestamp T₂ and a second digital signal value representative of a logic zero, to the controller 314 via the network switch 310. Advantageously, the controller 314 can generate a sequence of events based on the first digital signal value, the first timestamp, the second digital signal value, and the second timestamp. For example, the controller 314 can generate a sequence of events that includes a change in the digital signal value from a logic one at the first timestamp to a logic zero at the second timestamp.

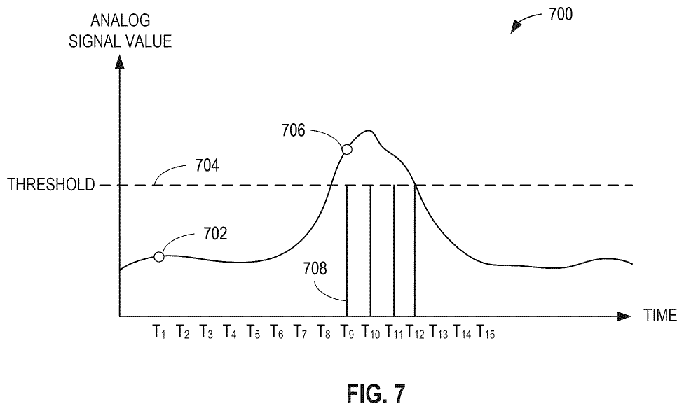

FIG. 7 depicts a second graph 700 of example analog signals with respect to time. In some examples, the values of analog signals are generated and/or otherwise outputted by an electronic device, such as the fifth field device 306, the sixth field device 308, the seventh field device 332, and/or the I/O system 312 of FIG. 3. By way of example, the sixth field device 308 can determine that a first example analog signal value 702 (e.g., a current signal, a voltage signal, etc.) from a pressure sensor of the sixth fluid flow control assembly 304 at a first time (identified by a first timestamp T₁ in the second graph 700) is below an example threshold 704. For example, the threshold 704 can be 16 mA and the first analog signal value 702 is 6 mA. In some examples, the first analog signal value 702 can correspond to a first pressure measurement of 100 PSI and the threshold 704 can correspond to a pressure threshold of 250 PSI. In some examples, the sixth field device 308 can transmit a first event, which can include a value of the first timestamp T₁ and the first analog signal value 702 to the controller 314 via the network switch 310. Alternatively, the sixth field device 308 may transmit the first event to include a value of the first timestamp T₁ and a digital value (e.g., a logic zero) corresponding to the first analog signal value 702 being below the threshold 704.

By way of another example, the sixth field device 308 can determine that a second example analog signal value 706 from the pressure sensor of the sixth fluid flow control assembly 304 at a second time (identified by a second timestamp T₉ in the second graph 700) is above the threshold 704. For example, the threshold 704 can be 16 mA and the second analog signal value 706 can be 18 mA. In some examples, the second analog signal value 706 can correspond to a second pressure measurement of 300 PSI and the threshold 704 can correspond to a pressure threshold of 250 PSI. For example, the second analog signal value 706 of 18 mA and the second pressure measurement of 300 can satisfy the threshold 704 of 16 mA and 250 PSI, respectively. In some examples, the sixth field device 308 can transmit a second event, which can include a value of the second timestamp T₉ and the second analog signal value 706 to the controller 314 via the network switch 310. Alternatively, the sixth field device 308 may transmit the second event to include a value of the second timestamp T₉ and an example digital value 708 (e.g., a logic one) corresponding to the second analog signal value 706 being above the threshold 704.

Advantageously, the controller 314 can generate a sequence of events based on the first analog signal value 702, the first timestamp, the second analog signal value 706, and the second timestamp. For example, the controller 314 can generate a sequence of events that includes a change in the analog signal value from 8 mA at T₁ to 18 mA at T₉. In some examples, the controller 314 can generate a sequence of events that includes a change in a digital signal value from a logic zero at T₁ to a logic one at T₉.

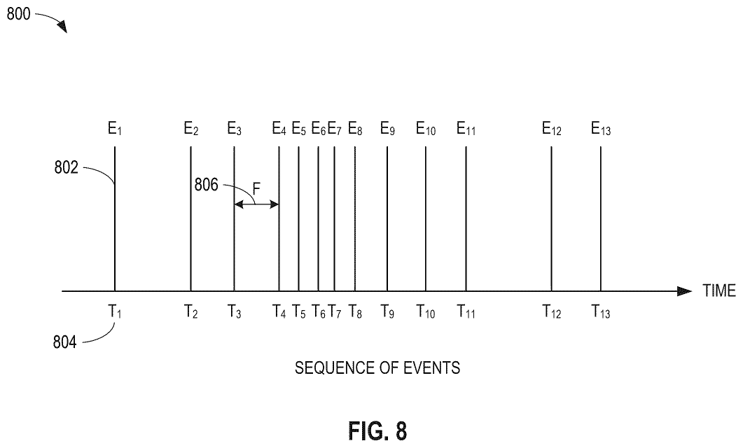

FIG. 8 depicts an example sequence of events 800 associated with an example process control system, such as the second process control system 200 of FIG. 2 and/or the third process control system 300 of FIG. 3. In some examples, the network switch 210, the controller 214, and/or the computing system 216 of FIG. 2 can generate, create, aggregate, and/or otherwise output the sequence of events 800 (or more generally an event sequence, a process event sequence, or a process control event sequence). In some examples, the network switch 310, the controller 314, and/or the computing system 316 of FIG. 3 can generate, create, aggregate, and/or otherwise output the sequence of events 800. In some examples, the event sequence generation circuitry 450), and/or, more generally, the control circuitry 400 of FIG. 4, can generate, create, aggregate, and/or otherwise output the sequence of events 800. In some examples, the interface circuitry 510, and/or, more generally, the field device circuitry 500 of FIG. 5, can cause and/or otherwise invoke a generation, creation, aggregation, and/or otherwise output of the sequence of events 800.

The sequence of events 800 of the illustrated example of FIG. 8 includes a plurality of example events 802 (identified by E₁-E₁₃) with respect to time. For example, the events 802 can be arranged and/or otherwise organized in a sequential manner based on their respective example timestamps 804 (identified by T₁-T₁₃). The events 802 of the illustrated example can include, correspond to, and/or otherwise be representative of event data. For example, the event data can include an event identifier (e.g., an event identifier of E₁), a type of event (e.g., an event type of E₁), an identifier of a field device that generated the event, a sensor measurement, a network identifier (e.g., an IP address and/or port, a MAC address, etc.), etc., and/or any combination(s) thereof. In some examples, the events 802, and/or, more generally, the sequence of events 800, can be stored in a datastore, such as the event sequence data 466 in the datastore 460 of FIG. 4.

By way of example, a first one of the events 802 (identified by E₁) can be representative of a first sensor measurement of a sensor of the third fluid flow control assembly 202 of FIG. 2. The first one of the events 802 can be marked, labeled, and/or otherwise associated with a first one of the timestamps 804 (identified by T₁). Advantageously, the first one of the timestamps 804, and/or more generally, the timestamps 804, can be generated by a field device and/or I/O system that observed the corresponding ones of the events 802 to achieve improved accuracy of the sequence of events 800. By way of example, an example failure 806 (e.g., a blown seal, burst disc, etc., in the third valve 222 of FIG. 2) in the second process control system 200 may have occurred between T₃ and T₄. Advantageously, the event sequence generation circuitry 450, and/or, more generally, the control circuitry 400, can determine potential root cause(s) of the failure 806 by analyzing and/or inspecting events prior to the failure 806, such as E₁, E₂, E₃. Advantageously, the event sequence generation circuitry 450, and/or, more generally, the control circuitry 400, can improve operation of a process control system by identifying root cause(s) of failure(s) and carrying out mitigation or prevention measures to avoid similar latent defects in the process control system.

Flowcharts representative of example machine readable instructions, which may be executed to configure processor circuitry to implement the control circuitry 400 of FIG. 4, are shown in FIGS. 9, 10, 11, 13, and/or 15. The machine readable instructions may be one or more executable programs or portion(s) of an executable program for execution by processor circuitry, such as the processor circuitry 1712 shown in the example processor platform 1700 discussed below in connection with FIG. 17 and/or the example processor circuitry discussed below in connection with FIGS. 19 and/or 20.

Flowcharts representative of example machine readable instructions, which may be executed to configure processor circuitry to implement the field device circuitry 500 of FIG. 5, are shown in FIGS. 12-16. The machine readable instructions may be one or more executable programs or portion(s) of an executable program for execution by processor circuitry, such as the processor circuitry 1812 shown in the example processor platform 1800 discussed below in connection with FIG. 18 and/or the example processor circuitry discussed below in connection with FIGS. 19 and/or 20.

The program(s) may be embodied in software stored on one or more non-transitory computer readable storage media such as a CD, a floppy disk, an HDD, an SSD, a DVD, a Blu-ray disk, a volatile memory (e.g., Random Access Memory (RAM) of any type, etc.), or a non-volatile memory (e.g., electrically erasable programmable read-only memory (EEPROM), FLASH memory, an HDD, an SSD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN), a network switch, a network gateway, etc.) that may facilitate communication between a server and an endpoint client hardware device. Similarly, the non-transitory computer readable storage media may include one or more mediums located in one or more hardware devices. Further, although the example program(s) is/are described with reference to the flowcharts illustrated in FIGS. 9, 10, 11, 12, 13, 14, 15, and/or 16, many other methods of implementing the example control circuitry 400 of FIG. 4 and/or the field device circuitry 500 of FIG. 5 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU, an XPU, etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C #, Perl, Python, JavaScript. HyperText Markup Language (HTML), SQL, Swift, etc.

As mentioned above, the example operations of FIGS. 9-16 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium, non-transitory computer readable storage medium, non-transitory machine readable medium, and non-transitory machine readable storage medium are expressly defined to include any type of computer readable storage device and/or storage disk and to exclude propagating signals and to exclude transmission media. As used herein, the terms “computer readable storage device” and “machine readable storage device” are defined to include any physical (mechanical and/or electrical) structure to store information, but to exclude propagating signals and to exclude transmission media. Examples of computer readable storage devices and machine readable storage devices include random access memory of any type, read only memory of any type, solid state memory, flash memory, optical discs. magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer readable instructions, machine readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A. (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes. instructions, actions, activities and/or steps, the phrase “at least one of A and B” is intended to refer to implementations including any of (1) at least one A. (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 9 is a flowchart representative of example machine readable instructions and/or example operations 900 that may be executed and/or instantiated by processor circuitry to generate a sequence of events associated with a process control system. The example machine readable instructions and/or the example operations 900 of FIG. 9 begin at block 902, at which the control circuitry 400 obtains a first digital signal from a first field device in a process control system, the first digital signal representative of a first sensor data value labeled with a first timestamp, the first timestamp to be generated by the first field device. For example, the interface circuitry 410 (FIG. 4) can obtain a first digital signal based on a TCP/IP data format from the third field device 206 via the network switch 210. In some examples, the first digital signal can correspond to first data representative of whether the third valve 222 is open or closed. In some examples, the first data can include a first timestamp generated by the third field device 206 to be associated with the open/closed position of the third valve 222. For example, the interface circuitry 410 can store the first data, or portion(s) thereof, in the datastore 460 as the sensor measurement data 464.

At block 904, the control circuitry 400 obtains a second digital signal from a second field device in the process control system, the second digital signal representative of a second sensor data value labeled with a second timestamp, the second timestamp to be generated by the second field device. For example, the interface circuitry 410 can obtain a second digital signal based on a TCP/IP data format from the fourth field device 208 via the network switch 210. In some examples, the second digital signal can correspond to second data representative of a pressure measurement of fluid flowing through the fourth valve 224 is open or closed. In some examples, the second data can include a second timestamp generated by the fourth field device 208 to be associated with the pressure measurement of the fourth valve 224. For example, the interface circuitry 410 can store the second data, or portion(s) thereof, in the datastore 460 as the sensor measurement data 464.

At block 906, the control circuitry 400 stores a data association of the first sensor data value and the second sensor data value in a datastore, the data association representative of a sequence of events associated with the process control system, the sequence of events to include an ordering of the first sensor data value and the second sensor data value based on the first timestamp and the second timestamp. For example, the event sequence generation circuitry 450) (FIG. 4) can generate the sequence of events 800 based on the first timestamp, the open/closed position of the third valve 222, the second timestamp. and the pressure measurement. In some examples, the sequence of events can include an ordering of the open/closed position of the third valve 222 at the first timestamp followed by the pressure measurement of the fourth valve 224 at the second timestamp. For example, the event sequence generation circuitry 450 can store the sequence of events in the datastore 460) as the event sequence data 466. In some examples, the sequence of events can be implemented by a data association of the first timestamp, the open/closed position of the third valve 222, the second timestamp, and the pressure measurement in the datastore 460 as the event sequence data 466.

Advantageously, the event sequence generation circuitry 450 and/or personnel associated with the second process control system 200 can identify a root cause of an issue associated with the third field device 206 and/or the fourth field device 208 based on the sequence of events. For example, the issue can be a blown burst disc in the fourth valve 224 and the root cause of the issue may be an unintentional opening of the third valve 222. In some examples, the event sequence generation circuitry 450 can identify the root cause based on the sequence of events. In response to storing a data association of the first sensor data value and the second sensor data value in a datastore at block 906, the example machine readable instructions and/or the example operations 900 of FIG. 9 conclude.

FIG. 10 is another flowchart representative of example machine readable instructions and/or example operations 1000 that may be executed and/or instantiated by processor circuitry to generate a sequence of events associated with a process control system. The example machine readable instructions and/or the example operations 1000 of FIG. 10 begin at block 1002, at which the control circuitry 400 synchronizes at least one of (i) a first clock of a first field device (ii) a second clock of a second field device or (iii) a third clock of an Input/Output (I/O) system with a fourth clock of a controller. For example, the time synchronization circuitry 420 (FIG. 4) can synchronize at least one of a first clock of the fifth field device 306, a second clock of the sixth field device 308, a third clock of the I/O system 312, or a fourth clock of the controller 314.

At block 1004, the control circuitry 400 synchronizes at least one of the first clock, the second clock, or the third clock with one(s) of each other. For example, the time synchronization circuitry 420 can synchronize at least one of the first clock of the fifth field device 306, the second clock of the sixth field device 308, or the third clock of the I/O system 312.

At block 1006, the control circuitry 400 obtains a first digital signal from the first field device, the first digital signal representative of a first sensor data value labeled with a first timestamp, the first timestamp to be generated by the first field device. For example, the interface circuitry 410 can obtain a first TCP/IP data packet from the fifth field device 306, which can include first data corresponding to (i) a first sensor data value from the fifth field device 306 and (ii) a first timestamp generated by the fifth field device 306 at a time at which the first sensor data value is measured, determined, generated, etc., by the fifth field device 306.

At block 1008, the control circuitry 400 obtains a second digital signal from the second field device, the second digital signal representative of a second sensor data value labeled with a second timestamp, the second timestamp to be generated by the second field device. For example, the interface circuitry 410 can obtain a second TCP/IP data packet from the sixth field device 308, which can include second data corresponding to (i) a second sensor data value from the sixth field device 308 and (ii) a second timestamp generated by the sixth field device 308 at a time at which the second sensor data value is measured, determined, generated, etc., by the sixth field device 308.

At block 1010, the control circuitry 400 obtains a third digital signal from the I/O system, the third digital signal representative of a third sensor data value labeled with a third timestamp, the third timestamp to be generated by the I/O system. For example, the interface circuitry 410 can obtain a third TCP/IP data packet from the I/O system 312. which can include third data corresponding to (i) a third sensor data value from the seventh field device 332 and (ii) a third timestamp generated by the I/O system 312 at a time at which the third sensor data value is obtained from the seventh field device 332.

At block 1012, the control circuitry 400 records a data association of the first sensor data value, the second sensor data value, and the third sensor data value, the data association representative of a sequence of events including an ordering of the first sensor data value, the second sensor data value, and the third sensor data value based on the first timestamp, the second timestamp, and the third timestamp. For example, the event sequence generation circuitry 450) (FIG. 4) can generate the sequence of events 800 based on the first timestamp, the first sensor data value, the second timestamp, the second sensor data value, the third timestamp, and the third sensor data value. In some examples, the sequence of events can include an ordering of the first sensor data value at the first timestamp followed by the second sensor data value at the second timestamp and/or the third sensor data value at the third timestamp based on a determination that the first timestamp is prior or earlier than the second timestamp and the third timestamp. For example, the event sequence generation circuitry 450 can store the sequence of events in the datastore 460 as the event sequence data 466. In some examples, the sequence of events can be implemented by a data association of the first timestamp, the first sensor data value, the second timestamp, the second sensor data value, the third timestamp, and the third sensor data value in the datastore 460 as the event sequence data 466. In response to storing a data association of the first sensor data value, the second sensor data value, and the third sensor data value at block 1012, the example machine readable instructions and/or the example operations 1000 of FIG. 10 conclude.

FIG. 11 is a flowchart representative of example machine readable instructions and/or example operations 1100 that may be executed and/or instantiated by processor circuitry to generate a sequence of events based on sensor measurements from subscribing field devices. The example machine readable instructions and/or the example operations 1100 of FIG. 11 begin at block 1102, at which the control circuitry 400 selects a field device in a process control system to process. For example, the subscriber group generation circuitry 440 (FIG. 4) can select the fifth field device 306 to process.

At block 1104, the control circuitry 400 authenticates the field device to join the process control system. For example, the device authentication circuitry 430 (FIG. 4) can authenticate and/or otherwise validate the fifth field device 306 as being authorized to join the third process control system 300 based on security techniques described herein.

At block 1106, the control circuitry 400 determines whether the field device is associated with other field device(s). For example, the subscriber group generation circuitry 440 can determine that the fifth field device 306 is associated with at least one of the sixth field device 308 or the seventh field device 332 based on the field device configuration data 462 (FIG. 4), which can be stored in the fifth field device 306.

If, at block 1106, the control circuitry 400 determines that the field device is not associated with other field device(s), control proceeds to block 1110, otherwise control proceeds to block 1108.

At block 1108, the control circuitry 400 generates an event subscription identifier (ID) to identify the field device as a subscriber to the other field device(s). For example, the subscriber group generation circuitry 440 can generate an event subscription ID that associates the fifth field device 306 and the sixth field device 308. In some examples, the subscriber group generation circuitry 440 can identify the fifth field device 306 as a subscriber (e.g., a subscriber field device) to events generated by the sixth field device 308.

At block 1110, the control circuitry 400 determines whether to select another field device in the process control system to process. For example, the subscriber group generation circuitry 440 can determine to select the sixth field device 308 to process.

If, at block 1110, the control circuitry 400 determines to select another field device in the process control system to process, control returns to block 1102, otherwise control proceeds to block 1112.

At block 1112, the control circuitry 400 transmits configuration data including the event subscription ID to the field device(s), the event subscription ID to identify field device(s) as subscriber(s) to other field device(s). For example, the subscriber group generation circuitry 440 can transmit the field device configuration data 462, which can include the event subscriber ID, to the fifth field device 306 and the sixth field device 308.

At block 1114, the control circuitry 400 determines whether a field device broadcasted an event including the event subscription ID. For example, the subscriber group generation circuitry 440 can determine that the sixth field device 308 generated an event, which can include the event subscription ID. In some examples, the subscriber group generation circuitry 440 can map the event subscription ID to a data association of the fifth field device 306 as a subscriber field device and the sixth field device 308 as a publisher field device.

If, at block 1114, the control circuitry 400 determines that a field device did not broadcast an event including the event subscription ID, control proceeds to block 1120, otherwise control proceeds to block 1116.

At block 1116, the control circuitry 400 obtains sensor measurement data from the subscribing field device(s) associated with the field device based on the event subscription ID. For example, the interface circuitry 410 (FIG. 4) can obtain a second event (e.g., an event including sensor measurement data) from a subscriber field device, such as the fifth field device 306, in response to a publisher field device, such as the sixth field device 308, publishing a first event.

At block 1118, the control circuitry 400 generates a sequence of events based on the sensor measurement data from the subscribing field device(s). For example, the event sequence generation circuitry 450 (FIG. 4) can generate the sequence of events 800 based on the first event from the publisher field device and the second event from the subscriber field device. In some examples, the event sequence generation circuitry 450 can generate the sequence of events as an ordering of the first event followed by the second event based on a determination that a first timestamp of the first event is prior to a second timestamp of the second event.

At block 1120, the control circuitry 400 determines whether to continue monitoring the process control system. For example, the interface circuitry 410 can determine whether additional event(s) have been generated by one(s) of the field devices 306. 308, 332 of FIG. 3. If, at block 1120, the control circuitry 400 determines to continue monitoring the process control system, control returns to block 1114, otherwise the example machine readable instructions and/or the example operations 1100 of FIG. 11 conclude.

FIG. 12 is a flowchart representative of example machine readable instructions and/or example operations 1200 that may be executed and/or instantiated by processor circuitry to cause a generation of a sequence of events associated with a process control system. The example machine readable instructions and/or the example operations 1200 of FIG. 12 begin at block 1202, at which the field device circuitry 500, after determining that a measurement period associated with a field device in a process control system is triggered, records a timestamp at the field device during the measurement period. For example, the timestamp recordation circuitry 530 (FIG. 5) can determine that a measurement period associated with the fifth field device 306 has been triggered and/or otherwise invoked. In some examples, the timestamp recordation circuitry 530 can generate a timestamp using a clock generator (e.g., clock generation circuitry) to identify a beginning of the measurement period.

At block 1204, the field device circuitry 500 records a digital value based on a sensor measurement associated with the timestamp at the field device. For example, the measurement recordation circuitry 540 (FIG. 5) can record a sensor measurement associated with the timestamp at the field device. For example, the measurement recordation circuitry 540 (FIG. 5) can record a sensor data value from a sensor, such as a position sensor of the fifth fluid flow control assembly 302, at a time that corresponds to the first timestamp.

At block 1206, the field device circuitry 500 transmits a digital signal representative of at least one of the timestamp or the sensor measurement from the field device to an electronic device using a network communication protocol. For example, the interface circuitry 510 (FIG. 5) can transmit one or more TCP/IP packets implemented by one or more digital signals from the fifth field device 306 to the controller 314 via the network switch 310. In some examples, the one or more TCP/IP packets can implement an event, which can include at least one of the timestamp or the sensor data value.

At block 1208, the field device circuitry 500 causes a generation of a sequence of events associated with the field device based on the digital signal. For example, the interface circuitry 510 can cause the controller 314 to generate the sequence of events 800 by transmitting the one or more digital signals to the controller 314. In some examples, the sequence of events can include at least one of the timestamp or the sensor data value. In response to causing a generation of a sequence of events associated with the field device based on the digital signal at block 1208, the example machine readable instructions and/or the example operations 1200 of FIG. 12 conclude.

FIG. 13 is another flowchart representative of example machine readable instructions and/or example operations 1300 that may be executed and/or instantiated by processor circuitry to cause a generation of a sequence of events associated with a process control system. The example machine readable instructions and/or the example operations 1300 of FIG. 13 begin at block 1302, at which the control circuitry 400 selects a field device in a process control system to process. For example, the interface circuitry 410 (FIG. 4) and/or the event sequence generation circuitry 450 (FIG. 4) can select the third field device 206 of the second process control system 200 to process and/or otherwise obtain data from.

At block 1304, the field device circuitry 500 determines whether a measurement period associated with the field device is triggered. For example, the measurement recordation circuitry 540 (FIG. 5) can determine that a measurement period (e.g., a period in which a field device is to measure process parameter(s) with sensor(s)) is to be triggered and/or otherwise invoked.

If, at block 1304, the field device circuitry 500 determines that a measurement period associated with the field device is not triggered, control proceeds to block 1318, otherwise control proceeds to block 1306.

At block 1306, the field device circuitry 500 records a first timestamp at the field device at a beginning of the measurement period. For example, the timestamp recordation circuitry 530 (FIG. 5) can record a first timestamp at a beginning of the measurement period.

At block 1308, the field device circuitry 500 records a first sensor measurement associated with the first timestamp. For example, the measurement recordation circuitry 540 (FIG. 5) can record a first sensor measurement from a position sensor (or any other sensor) of the third fluid flow control assembly 202 to be in association with and/or otherwise correspond to the first timestamp.

At block 1310, the field device circuitry 500 transmits first data including the first timestamp and the first sensor measurement from the field device to an electronic device using a network communication protocol. For example, the interface circuitry 510 (FIG. 5) can generate one or more first network packets, such as TCP/IP packets, to include the first timestamp and the first sensor measurement. In some examples, the interface circuitry 510 can transmit the one or more first network packets to the controller 214 via the network switch 210.

At block 1312, the field device circuitry 500 records a second timestamp at the field device at an end of the measurement period. For example, the timestamp recordation circuitry 530 can record a second timestamp at an end of the measurement period.

At block 1314, the field device circuitry 500 records a second sensor measurement associated with the second timestamp. For example, the measurement recordation circuitry 540 can record a second sensor measurement from the position sensor (or any other sensor) of the third fluid flow control assembly 202 to be in association with and/or otherwise correspond to the second timestamp.

At block 1316, the field device circuitry 500 transmits second data including the second timestamp and the second sensor measurement from the field device to the electronic device using the network communication protocol. For example, the interface circuitry 510 can generate one or more second network packets, such as TCP/IP packets, to include the second timestamp and the second sensor measurement. In some examples, the interface circuitry 510 can transmit the one or more second network packets to the controller 214 via the network switch 210.

At block 1318, the control circuitry 400 determines whether to select another field device to process. For example, the interface circuitry 410 and/or the event sequence generation circuitry 450 can select the fourth field device 208 of the second process control system 200 to process and/or otherwise obtain data from.

If, at block 1318, the control circuitry 400 determines to select another field device to process, control returns to block 1302, otherwise control proceeds to block 1320.

At block 1320, the field device circuitry 500 causes a generation of a sequence of events for the field device(s) based on at least one of the first data or the second data. For example, the interface circuitry 510 can cause and/or otherwise invoke the event sequence generation circuitry 450 to generate the sequence of events 800 including an arrangement of the first sensor measurement and the second sensor measurement in sequence based on an ordering of the first timestamp and the second timestamp.

At block 1322, the field device circuitry 500 determines whether to continue monitoring the process control system. For example, the interface circuitry 410 and/or the event sequence generation circuitry 450 can determine to continue monitoring one(s) of the field devices 206, 208 of the second process control system 200 for additional events, sensor measurements, etc. If, at block 1322, the field device circuitry 500 determines to continue monitoring the process control system, control returns to block 1302, otherwise the example machine readable instructions and/or the example operations 1300 of FIG. 13 conclude.

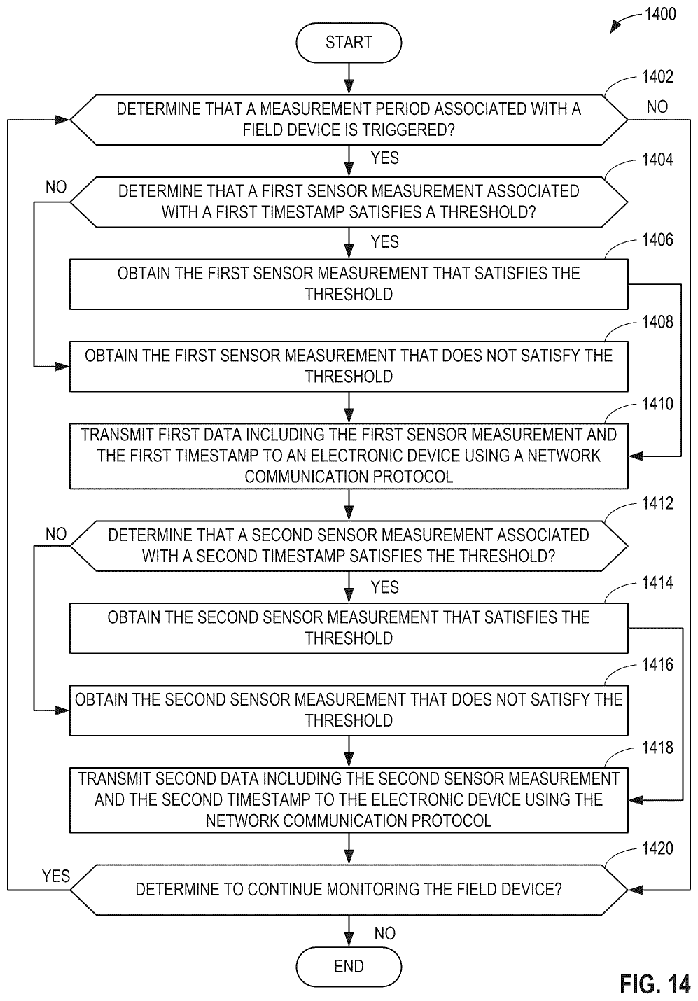

FIG. 14 is a flowchart representative of example machine readable instructions and/or example operations 1400 that may be executed and/or instantiated by processor circuitry to obtain sensor measurement(s) satisfying threshold(s). The example machine readable instructions and/or the example operations 1400 of FIG. 14 begin at block 1402, at which the field device circuitry 500 determines whether a measurement period associated with a field device is triggered. For example, the measurement recordation circuitry 540 (FIG. 5) can determine that a new measurement period for the fourth field device 208 is to begin.

If, at block 1402, the field device circuitry 500 determines that a measurement period associated with a field device is not triggered, control proceeds to block 1420, otherwise control proceeds to block 1404.

At block 1404, the field device circuitry 500 determines whether a first sensor measurement associated with a first timestamp satisfies a threshold. For example, the measurement recordation circuitry 540 can determine that the first analog signal value 702 of FIG. 7 at a first time T₁ marked with a first timestamp is below the threshold 704 of FIG. 7. In some examples, the first analog signal value 702 can correspond to a first sensor measurement from a sensor of the fourth fluid flow control assembly 204.

If, at block 1404, the field device circuitry 500 determines that a first sensor measurement associated with a first timestamp satisfies a threshold, then, at block 1406, the field device circuitry 500 obtains the first sensor measurement that satisfies the threshold. For example, the measurement recordation circuitry 540 can record the first sensor measurement, which can be an analog signal value such as 8 mA or a value of a corresponding process parameter such as a pressure of 100 PSI, in the datastore 550 as the sensor measurement data 554. In response to obtaining the first sensor measurement satisfying the threshold at block 1406, control proceeds to block 1410.

If, at block 1404, the field device circuitry 500 determines that a first sensor measurement associated with a first timestamp does not satisfy a threshold, control proceeds to block 1408.

At block 1408, the field device circuitry 500 obtains the first sensor measurement that does not satisfy the threshold. For example, the measurement recordation circuitry 540 can record the first analog signal value 702 and/or a value of a corresponding process parameter (e.g., a pressure, a temperature, etc., that the sensor is sensing, measuring, monitoring, etc.) in the datastore 550 as the sensor measurement data 554. In response to obtaining the first sensor measurement not satisfying the threshold, control proceeds to block 1410.

At block 1410, the field device circuitry 500 transmits first data including the first sensor measurement and the first timestamp to an electronic device using a network communication protocol. For example, the interface circuitry 510 (FIG. 5) can transmit the first sensor measurement and the first timestamp to the controller 214 via the network switch 210 using a network communication protocol, such as TCP/IP or other Ethernet-based communication protocol.

At block 1412, the field device circuitry 500 determines whether a second sensor measurement associated with a second timestamp satisfies the threshold. For example, the measurement recordation circuitry 540 can determine that the second analog signal value 706 of FIG. 7 at a ninth time To marked with a second timestamp is above the threshold 704 of FIG. 7. In some examples, the second analog signal value 706 can correspond to a second sensor measurement from the sensor of the fourth fluid flow control assembly 204.

If, at block 1412, the field device circuitry 500 determines that a second sensor measurement associated with a second timestamp satisfies the threshold, then, at block 1414, the field device circuitry 500 obtains the second sensor measurement that satisfies the threshold. For example, the measurement recordation circuitry 540 can record the second sensor measurement, which can be an analog signal value such as 18 mA or a value of a corresponding process parameter such as a pressure of 300 PSI, in the datastore 550 as the sensor measurement data 554. In response to obtaining the second sensor measurement satisfying the threshold at block 1414, control proceeds to block 1418.

If, at block 1412, the field device circuitry 500 determines that a second sensor measurement associated with a second timestamp does not satisfy the threshold, control proceeds to block 1416.

At block 1416, the field device circuitry 500 obtains the second sensor measurement that does not satisfy the threshold. For example, the measurement recordation circuitry 540 can record the second analog signal value 706 and/or a value of a corresponding process parameter (e.g., a pressure, a temperature, etc., that the sensor is sensing, measuring, monitoring, etc.) in the datastore 550 as the sensor measurement data 554. In response to obtaining the second sensor measurement not satisfying the threshold, control proceeds to block 1418.

At block 1418, the field device circuitry 500 transmits second data including the second sensor measurement and the second timestamp to the electronic device using the network communication protocol. For example, the interface circuitry 510 can transmit the second sensor measurement and the second timestamp to the controller 214 via the network switch 210 using a network communication protocol, such as TCP/IP or other Ethernet-based communication protocol.

At block 1420, the field device circuitry 500 determines whether to continue monitoring the field device. For example, the measurement recordation circuitry 540 can determine whether to continue obtaining sensor data measurements from the fourth field device 208 to support diagnostic capabilities of the second process control system 200, such as collecting event data to create sequences of events (e.g., process control events).

If, at block 1420, the field device circuitry 500 determines to continue monitoring the field device, control returns to block 1402, otherwise the example machine readable instructions and/or the example operations 1400 of FIG. 14 conclude.

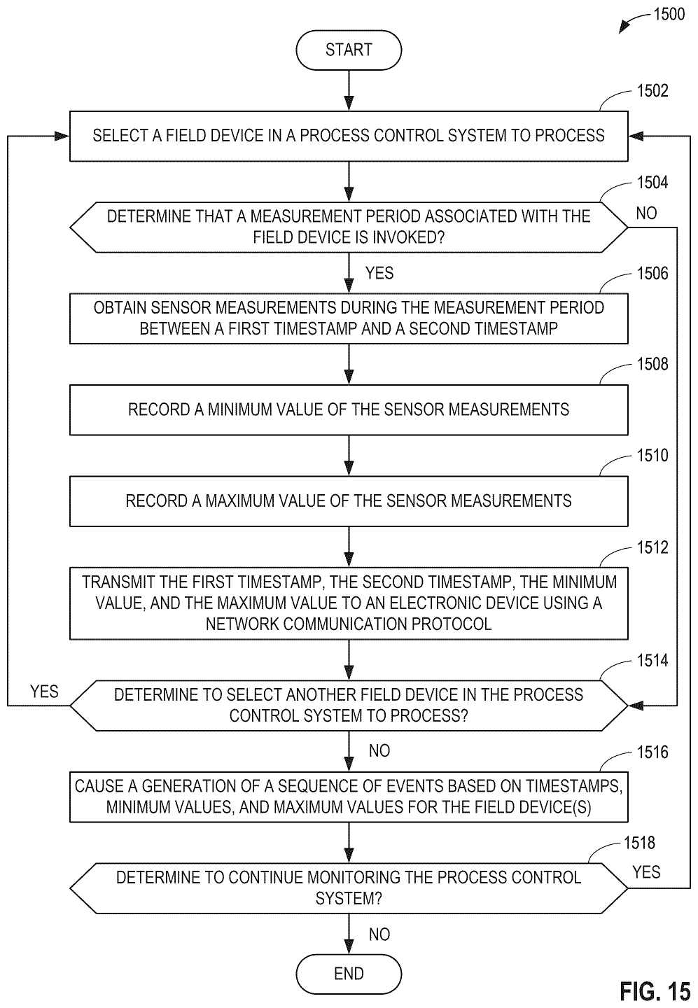

FIG. 15 is a flowchart representative of example machine readable instructions and/or example operations 1500 that may be executed and/or instantiated by processor circuitry to cause a generation of a sequence of events associated with a process control system based on minimum and/or maximum value(s) of sensor measurement(s). The example machine readable instructions and/or the example operations 1500 of FIG. 15 begin at block 1502, at which the control circuitry 400 selects a field device in a process control system to process. For example, the interface circuitry 410 and/or the event sequence generation circuitry 450 can select the fourth field device 208 to process and/or otherwise obtain events, sensor measurements, etc., from.

At block 1504, the field device circuitry 500 determines whether a measurement period associated with the field device is invoked. For example, the measurement recordation circuitry 540 (FIG. 5) can determine whether a time period in which to obtain sensor measurements from a sensor of the fourth fluid flow control assembly 204 is to be triggered.

If, at block 1504, the field device circuitry 500 determines that a measurement period associated with the field device is not invoked, control proceeds to block 1514, otherwise control proceeds to block 1506.

At block 1506, the field device circuitry 500 obtains sensor measurements during the measurement period between a first timestamp and a second timestamp. For example, the measurement recordation circuitry 540 can obtain sensor measurements from a first time, such as T₁ in the second graph 700, to a ninth time, such as T₉ in the second graph 700.

At block 1508, the field device circuitry 500 records a minimum value of the sensor measurements. For example, the measurement recordation circuitry 540 can record the first analog signal value 702 as the minimum value of the sensor measurements recorded from T₁ to T₉.

At block 1510, the field device circuitry 500 records a maximum value of the sensor measurements. For example, the measurement recordation circuitry 540 can record the second analog signal value 706 as the maximum value of the sensor measurements recorded from T₁ to T₉.

At block 1512, the field device circuitry 500 transmits the first timestamp, the second timestamp, the minimum value, and the maximum value to an electronic device using a network communication protocol. For example, the interface circuitry 510 (FIG. 5) can transmit a first timestamp value corresponding to T₁, a second timestamp value corresponding to T₉, the first analog signal value 702, and the second analog signal value 706 to the controller 214 via the network switch 210 using a network communication protocol such as Ethernet or an Ethernet-based protocol.

At block 1514, the control circuitry 400 determines whether to select another field device in the process control system to process. For example, the interface circuitry 410 and/or the event sequence generation circuitry 450 can determine whether to select the third field device 206 of the second process control system 200 to process.

If, at block 1514, the control circuitry 400 determines to select another field device in the process control system to process, control returns to block 1502, otherwise control proceeds to block 1516.

At block 1516, the field device circuitry 500 causes a generation of a sequence of events based on timestamps, minimum values, and maximum values for the field device(s). For example, the interface circuitry 510 can cause the event sequence generation circuitry 450, and/or, more generally, the control circuitry 400, to generate a sequence of events based on a plurality of events from a plurality of field devices of the second process control system 200.

At block 1518, the control circuitry 400 determines whether to continue monitoring the process control system. For example, the interface circuitry 410 and/or the event sequence generation circuitry 450 can determine to continue monitoring for events associated with one(s) of the field devices 206, 208 of the second process control system 200.

If, at block 1518, the control circuitry 400 determines to continue monitoring the process control system, control returns to block 1502, otherwise the example machine readable instructions and/or the example operations 1500 of FIG. 15 conclude.

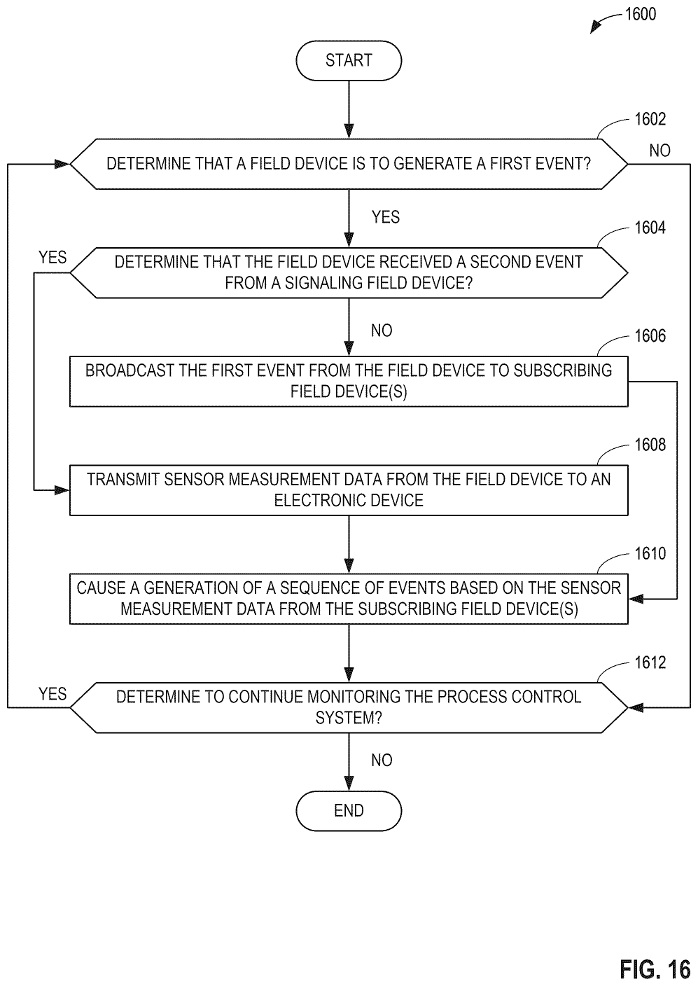

FIG. 16 is a flowchart representative of example machine readable instructions and/or example operations 1600 that may be executed and/or instantiated by processor circuitry to implement event storm prevention. The example machine readable instructions and/or the example operations 1600 of FIG. 16 begin at block 1602, at which the field device circuitry 500 determines whether a field device is to generate a first event. For example, the measurement recordation circuitry 540 (FIG. 5) can determine that the fifth field device 306 is to generate a first event after a determination that a pressure measurement from a pressure sensor of the fifth fluid flow control assembly 302 spiked above a pressure threshold.

If, at block 1602, the field device circuitry 500 determines that a field device is not to generate a first event, control proceeds to block 1612, otherwise control proceeds to block 1604.

At block 1604, the field device circuitry 500 determines whether the field device received a second event from a signaling field device. For example, the interface circuitry 510 (FIG. 5) can determine that a second event is received from the sixth field device 308. In some examples, the interface circuitry 510 can determine that the second event indicates that a pressure measurement from a pressure sensor of the sixth fluid flow control assembly 304 also spiked above a pressure threshold. For example, the interface circuitry 510 can determine that the first event and the second event are related and that an event storm may occur if not prevented.

If, at block 1604, the field device circuitry 500 determines that the field device did not receive a second event from a signaling field device, control proceeds to block 1606.

At block 1606, the field device circuitry 500 broadcasts the first event from the field device to subscribing field device(s). For example, after a determination that an event storm is not to occur, the interface circuitry 510 can broadcast, propagate, and/or otherwise transmit the first event to field device(s) that subscribe to the fifth field device 306. In some examples, the interface circuitry 510 can determine based on the field device configuration data 552 that the sixth field device 308 is a subscriber to the fifth field device 306. For example, the interface circuitry 510 can transmit the first event to an IP address associated with the sixth field device 308. In response to broadcasting the first event from the field device to subscribing field device(s) at block 1606, control proceeds to block 1610.

If, at block 1604, the field device circuitry 500 determines that the field device received a second event from a signaling field device, control proceeds to block 1608.

At block 1608, the field device circuitry 500 transmits sensor measurement data from the field device to an electronic device. For example, the interface circuitry 510 can transmit one or more sensor measurements from one or more sensors of the fifth fluid flow control assembly 302 to the controller 314 (e.g., by way of the network switch 310). Advantageously, the interface circuitry 510 can prevent an event storm from occurring by the one or more sensor measurements to the controller 314 instead of broadcasting its own events to subscriber field devices and thereby flooding the third process control system 300 with redundant or extraneous events.

After transmitting sensor measurement data from the field device to an electronic device at block 1608, control proceeds to block 1610. At block 1610, the field device circuitry 500 causes a generation of a sequence of events based on the sensor measurement data from the subscribing field device(s). For example, the interface circuitry 510 can cause the event sequence generation circuitry 450 to generate the sequence of events 800 based on the one or more sensor measurements, events, etc., from one(s) of the field devices 306, 308, 332 and/or the I/O system 312 of FIG. 3.

At block 1612, the field device circuitry 500 determines whether to continue monitoring the process control system. For example, the measurement recordation circuitry 540 can determine whether the fifth field device 306 is to generate another event, a measurement period is to be triggered, etc.

If, at block 1612, the field device circuitry 500 determines to continue monitoring the process control system, control returns to block 1602, otherwise the example machine readable instructions and/or the example operations 1600 of FIG. 16 conclude.

FIG. 17 is a block diagram of an example processor platform 1700 structured to execute and/or instantiate the example machine readable instructions and/or the example operations of FIGS. 9, 10, 11, 13, and/or 15 to implement the example control circuitry 400 of FIG. 4. The processor platform 1700 can be, for example, a server, a personal computer, a workstation, a self-learning machine (e.g., a neural network), a mobile device (e.g., a cell phone, a smart phone, a tablet such as an iPad™), a headset (e.g., an augmented reality (AR) headset, a virtual reality (VR) headset, etc.) or other wearable device, a programmable logic controller (PLC), or any other type of computing device.

The processor platform 1700 of the illustrated example includes processor circuitry 1712. The processor circuitry 1712 of the illustrated example is hardware. For example, the processor circuitry 1712 can be implemented by one or more integrated circuits, logic circuits, FPGAs, microprocessors, CPUs, GPUs, DSPs, and/or microcontrollers from any desired family or manufacturer. The processor circuitry 1712 may be implemented by one or more semiconductor based (e.g., silicon based) devices. In this example, the processor circuitry 1712 implements the time synchronization circuitry 420 (identified by TIME SYNCH CIRCUITRY), the device authentication circuitry 430 (identified by DEVICE AUTH CIRCUITRY), the subscriber group generation circuitry 440 (identified by SUBS GROUP GEN CIRCUITRY), and the event sequence generation circuitry 450 (identified by EVENT SEQ GEN CIRCUITRY) of FIG. 4.

The processor circuitry 1712 of the illustrated example includes a local memory 1713 (e.g., a cache, registers, etc.). The processor circuitry 1712 of the illustrated example is in communication with a main memory including a volatile memory 1714 and a non-volatile memory 1716 by a bus 1718. In this example, the bus 1718 can implement the bus 470 of FIG. 4. The volatile memory 1714 may be implemented by Synchronous SDRAM, DRAM, RDRAM®, and/or any other type of RAM device. The non-volatile memory 1716 may be implemented by flash memory and/or any other desired type of memory device. Access to the main memory 1714, 1716 of the illustrated example is controlled by a memory controller 1717.

The processor platform 1700 of the illustrated example also includes interface circuitry 1720. The interface circuitry 1720 may be implemented by hardware in accordance with any type of interface standard, such as an Ethernet interface, a universal serial bus (USB) interface, a Bluetooth®; interface, a near field communication (NFC) interface, a PCI interface, and/or a PCIe interface. In this example, the interface circuitry 1720 implements the interface circuitry 410 of FIG. 4.

In the illustrated example, one or more input devices 1722 are connected to the interface circuitry 1720. The input device(s) 1722 permit(s) a user to enter data and/or commands into the processor circuitry 1712. The input device(s) 1722 can be implemented by, for example, an audio sensor, a microphone, a camera (still or video), a keyboard, a button, a mouse, a touchscreen, a track-pad, a trackball, an isopoint device, and/or a voice recognition system.

One or more output devices 1724 are also connected to the interface circuitry 1720 of the illustrated example. The output device(s) 1724 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1720 of the illustrated example, thus, typically includes a graphics driver card, a graphics driver chip, and/or graphics processor circuitry such as a GPU.

The interface circuitry 1720 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1726. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 1700 of the illustrated example also includes one or more mass storage devices 1728 to store software and/or data. Examples of such mass storage devices 1728 include magnetic storage devices, optical storage devices, floppy disk drives, HDDs, CDs, Blu-ray disk drives, redundant array of independent disks (RAID) systems, solid state storage devices such as flash memory devices and/or SSDs, and DVD drives. In this example, the one or more mass storage devices 1728 implement the datastore 460 of FIG. 4, which includes the field device configuration data 462 (identified by FIELD DEVICE CONFIG DATA), the sensor measurement data 464 (identified by SENSOR DATA), and the event sequence data 466 (identified by EVENT SEQ DATA).

The machine readable instructions 1732, which may be implemented by the machine readable instructions of FIGS. 9, 10, 11, 13, and/or 15, may be stored in the mass storage device 1728, in the volatile memory 1714, in the non-volatile memory 1716, and/or on a removable non-transitory computer readable storage medium such as a CD or DVD.

FIG. 18 is a block diagram of an example processor platform 1800 structured to execute and/or instantiate the example machine readable instructions and/or the example operations of FIGS. 12-16 to implement the example field device circuitry 500 of FIG. 5. The processor platform 1800 can be, for example, a server, a personal computer, a workstation, a self-learning machine (e.g., a neural network), a mobile device (e.g., a cell phone, a smart phone, a tablet such as an iPad™), a personal digital assistant (PDA), a headset (e.g., an augmented reality (AR) headset, a virtual reality (VR) headset, etc.) or other wearable device, a PLC, a fluid flow control assembly, a field device, or any other type of computing device.

The processor platform 1800 of the illustrated example includes processor circuitry 1812. The processor circuitry 1812 of the illustrated example is hardware. For example, the processor circuitry 1812 can be implemented by one or more integrated circuits, logic circuits, FPGAs, microprocessors, CPUs, GPUs, DSPs, and/or microcontrollers from any desired family or manufacturer. The processor circuitry 1812 may be implemented by one or more semiconductor based (e.g., silicon based) devices. In this example, the processor circuitry 1812 implements the time synchronization circuitry 520 (identified by TIME SYNCH CIRCUITRY), the timestamp recordation circuitry 530 (identified by TIMESTAMP REC CIRCUITRY), and the measurement recordation circuitry 540) (identified by MEASUREMENT REC CIRCUITRY) of FIG. 5.

The processor circuitry 1812 of the illustrated example includes a local memory 1813 (e.g., a cache, registers, etc.). The processor circuitry 1812 of the illustrated example is in communication with a main memory including a volatile memory 1814 and a non-volatile memory 1816 by a bus 1818. In this example, the bus 1818 can implement the bus 560 of FIG. 5. The volatile memory 1814 may be implemented by SDRAM, DRAM, RDRAMR: , and/or any other type of RAM device. The non-volatile memory 1816 may be implemented by flash memory and/or any other desired type of memory device. Access to the main memory 1814, 1816 of the illustrated example is controlled by a memory controller 1817.

The processor platform 1800 of the illustrated example also includes interface circuitry 1820. The interface circuitry 1820 may be implemented by hardware in accordance with any type of interface standard, such as an Ethernet interface, a USB interface, a Bluetooth R; interface, an NFC interface, a PCI interface, and/or a PCIe interface. In this example, the interface circuitry 1820 implements the interface circuitry 510 of FIG. 5.

In the illustrated example, one or more input devices 1822 are connected to the interface circuitry 1820. The input device(s) 1822 permit(s) a user to enter data and/or commands into the processor circuitry 1812. The input device(s) 1822 can be implemented by, for example, an audio sensor, a microphone, a camera (still or video), a keyboard, a button, a mouse, a touchscreen, a track-pad, a trackball, an isopoint device, and/or a voice recognition system.

One or more output devices 1824 are also connected to the interface circuitry 1820 of the illustrated example. The output device(s) 1824 can be implemented, for example, by display devices (e.g., an LED, an OLED, an LCD, a CRT display, an IPS display, a touchscreen, etc.), a tactile output device, a printer, and/or speaker. The interface circuitry 1820 of the illustrated example, thus, typically includes a graphics driver card, a graphics driver chip, and/or graphics processor circuitry such as a GPU.

The interface circuitry 1820 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1826. The communication can be by, for example, an Ethernet connection, a DSL connection, a telephone line connection, a coaxial cable system, a satellite system, a line-of-site wireless system, a cellular telephone system, an optical connection, etc.

The processor platform 1800 of the illustrated example also includes one or more mass storage devices 1828 to store software and/or data. Examples of such mass storage devices 1828 include magnetic storage devices, optical storage devices, floppy disk drives, HDDs, CDs, Blu-ray disk drives, RAID systems, solid state storage devices such as flash memory devices and/or SSDs, and DVD drives.

The machine readable instructions 1832, which may be implemented by the machine readable instructions of FIGS. 12-16, may be stored in the mass storage device 1828, in the volatile memory 1814, in the non-volatile memory 1816, and/or on a removable non-transitory computer readable storage medium such as a CD or DVD.

FIG. 19 is a block diagram of an example implementation of the processor circuitry 1712 of FIG. 17 and/or the processor circuitry 1812 of FIG. 18. In this example, the processor circuitry 1712 of FIG. 17 and/or the processor circuitry 1812 of FIG. 18 is implemented by a microprocessor 1900. For example, the microprocessor 1900 may be a general purpose microprocessor (e.g., general purpose microprocessor circuitry). The microprocessor 1900 executes some or all of the machine readable instructions of the flowcharts of FIGS. 9-16 to effectively instantiate the control circuitry 400 of FIG. 4 and/or the field device circuitry 500 of FIG. 5 as logic circuits to perform the operations corresponding to those machine readable instructions. In some such examples. the control circuitry 400 of FIG. 4 and/or the field device circuitry 500 of FIG. 5 is instantiated by the hardware circuits of the microprocessor 1900 in combination with the instructions. For example, the microprocessor 1900 may be implemented by multi-core hardware circuitry such as a CPU, a DSP, a GPU, an XPU, etc. Although it may include any number of example cores 1902 (e.g., 1 core), the microprocessor 1900 of this example is a multi-core semiconductor device including N cores. The cores 1902 of the microprocessor 1900 may operate independently or may cooperate to execute machine readable instructions. For example, machine code corresponding to a firmware program, an embedded software program, or a software program may be executed by one of the cores 1902 or may be executed by multiple ones of the cores 1902 at the same or different times. In some examples, the machine code corresponding to the firmware program, the embedded software program, or the software program is split into threads and executed in parallel by two or more of the cores 1902. The software program may correspond to a portion or all of the machine readable instructions and/or operations represented by the flowcharts of FIGS. 9-16.

The cores 1902 may communicate by a first example bus 1904. In some examples, the first bus 1904 may be implemented by a communication bus to effectuate communication associated with one(s) of the cores 1902. For example, the first bus 1904 may be implemented by at least one of an Inter-Integrated Circuit (I2C) bus, a Serial Peripheral Interface (SPI) bus, a PCI bus, or a PCIe bus. Additionally or alternatively, the first bus 1904 may be implemented by any other type of computing or electrical bus. The cores 1902 may obtain data, instructions, and/or signals from one or more external devices by example interface circuitry 1906. The cores 1902 may output data, instructions, and/or signals to the one or more external devices by the interface circuitry 1906. Although the cores 1902 of this example include example local memory 1920 (e.g., Level 1 (L1) cache that may be split into an L1 data cache and an L1 instruction cache), the microprocessor 1900 also includes example shared memory 1910 that may be shared by the cores (e.g., Level 2 (L2 cache)) for high-speed access to data and/or instructions. Data and/or instructions may be transferred (e.g., shared) by writing to and/or reading from the shared memory 1910. The local memory 1920 of each of the cores 1902 and the shared memory 1910 may be part of a hierarchy of storage devices including multiple levels of cache memory and the main memory (e.g., the main memory 1714, 1716 of FIG. 17, the main memory 1814, 1816 of FIG. 18, etc.). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1902 may be referred to as a CPU, DSP, GPU, etc., or any other type of hardware circuitry. Each core 1902 includes control unit circuitry 1914, arithmetic and logic (AL) circuitry (sometimes referred to as an ALU) 1916, a plurality of registers 1918, the local memory 1920, and a second example bus 1922. Other structures may be present. For example, each core 1902 may include vector unit circuitry, single instruction multiple data (SIMD) unit circuitry, load/store unit (LSU) circuitry, branch/jump unit circuitry, floating-point unit (FPU) circuitry, etc. The control unit circuitry 1914 includes semiconductor-based circuits structured to control (e.g., coordinate) data movement within the corresponding core 1902. The AL circuitry 1916 includes semiconductor-based circuits structured to perform one or more mathematic and/or logic operations on the data within the corresponding core 1902. The AL circuitry 1916 of some examples performs integer based operations. In other examples. the AL circuitry 1916 also performs floating point operations. In yet other examples, the AL circuitry 1916 may include first AL circuitry that performs integer based operations and second AL circuitry that performs floating point operations. In some examples, the AL circuitry 1916 may be referred to as an Arithmetic Logic Unit (ALU). The registers 1918 are semiconductor-based structures to store data and/or instructions such as results of one or more of the operations performed by the AL circuitry 1916 of the corresponding core 1902. For example, the registers 1918 may include vector register(s). SIMD register(s), general purpose register(s), flag register(s), segment register(s), machine specific register(s), instruction pointer register(s), control register(s), debug register(s), memory management register(s), machine check register(s), etc. The registers 1918 may be arranged in a bank as shown in FIG. 19. Alternatively, the registers 1918 may be organized in any other arrangement, format, or structure including distributed throughout the core 1902 to shorten access time. The second bus 1922 may be implemented by at least one of an I2C bus, a SPI bus, a PCI bus, or a PCIe bus

Each core 1902 and/or, more generally, the microprocessor 1900 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1900 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

FIG. 20 is a block diagram of another example implementation of the processor circuitry 1712 of FIG. 17 and/or the processor circuitry 1812 of FIG. 18. In this example, the processor circuitry 1712 of FIG. 17 and/or the processor circuitry 1812 of FIG. 18 is implemented by FPGA circuitry 2000. For example, the FPGA circuitry 2000 may be implemented by an FPGA. The FPGA circuitry 2000 can be used, for example, to perform operations that could otherwise be performed by the example microprocessor 1900 of FIG. 19 executing corresponding machine readable instructions. However, once configured, the FPGA circuitry 2000 instantiates the machine readable instructions in hardware and, thus, can often execute the operations faster than they could be performed by a general purpose microprocessor executing the corresponding software.

More specifically, in contrast to the microprocessor 1900 of FIG. 19 described above (which is a general purpose device that may be programmed to execute some or all of the machine readable instructions represented by the flowcharts of FIGS. 9-16 but whose interconnections and logic circuitry are fixed once fabricated), the FPGA circuitry 2000 of the example of FIG. 20 includes interconnections and logic circuitry that may be configured and/or interconnected in different ways after fabrication to instantiate, for example, some or all of the machine readable instructions represented by the flowcharts of FIGS. 9-16. In particular, the FPGA circuitry 2000 may be thought of as an array of logic gates, interconnections, and switches. The switches can be programmed to change how the logic gates are interconnected by the interconnections, effectively forming one or more dedicated logic circuits (unless and until the FPGA circuitry 2000 is reprogrammed). The configured logic circuits enable the logic gates to cooperate in different ways to perform different operations on data received by input circuitry. Those operations may correspond to some or all of the software represented by the flowcharts of FIGS. 9-16. As such, the FPGA circuitry 2000 may be structured to effectively instantiate some or all of the machine readable instructions of the flowcharts of FIGS. 9-16 as dedicated logic circuits to perform the operations corresponding to those software instructions in a dedicated manner analogous to an ASIC. Therefore, the FPGA circuitry 2000 may perform the operations corresponding to the some or all of the machine readable instructions of FIGS. 9-16 faster than the general purpose microprocessor can execute the same.

In the example of FIG. 20, the FPGA circuitry 2000 is structured to be programmed (and/or reprogrammed one or more times) by an end user by a hardware description language (HDL) such as Verilog. The FPGA circuitry 2000 of FIG. 20, includes example input/output (I/O) circuitry 2002 to obtain and/or output data to/from example configuration circuitry 2004 and/or external hardware 2006. For example, the configuration circuitry 2004 may be implemented by interface circuitry that may obtain machine readable instructions to configure the FPGA circuitry 2000, or portion(s) thereof. In some such examples, the configuration circuitry 2004 may obtain the machine readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware 2006 may be implemented by external hardware circuitry. For example, the external hardware 2006 may be implemented by the microprocessor 1900 of FIG. 19. The FPGA circuitry 2000 also includes an array of example logic gate circuitry 2008, a plurality of example configurable interconnections 2010, and example storage circuitry 2012. The logic gate circuitry 2008 and the configurable interconnections 2010 are configurable to instantiate one or more operations that may correspond to at least some of the machine readable instructions of FIGS. 9-16 and/or other desired operations. The logic gate circuitry 2008 shown in FIG. 20 is fabricated in groups or blocks. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 2008 to enable configuration of the electrical structures and/or the logic gates to form circuits to perform desired operations. The logic gate circuitry 2008 may include other electrical structures such as look-up tables (LUTs), registers (e.g., flip-flops or latches), multiplexers, etc.

The configurable interconnections 2010 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 2008 to program desired logic circuits.

The storage circuitry 2012 of the illustrated example is structured to store result(s) of the one or more of the operations performed by corresponding logic gates. The storage circuitry 2012 may be implemented by registers or the like. In the illustrated example, the storage circuitry 2012 is distributed amongst the logic gate circuitry 2008 to facilitate access and increase execution speed.

The example FPGA circuitry 2000 of FIG. 20 also includes example Dedicated Operations Circuitry 2014. In this example, the Dedicated Operations Circuitry 2014 includes special purpose circuitry 2016 that may be invoked to implement commonly used functions to avoid the need to program those functions in the field. Examples of such special purpose circuitry 2016 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 2000 may also include example general purpose programmable circuitry 2018 such as an example CPU 2020 and/or an example DSP 2022. Other general purpose programmable circuitry 2018 may additionally or alternatively be present such as a GPU, an XPU, etc., that can be programmed to perform other operations.

Although FIGS. 19 and 20 illustrate two example implementations of the processor circuitry 1712 of FIG. 17 and/or the processor circuitry 1812 of FIG. 18. many other approaches are contemplated. For example, as mentioned above, modern FPGA circuitry may include an on-board CPU, such as one or more of the example CPU 2020 of FIG. 20. Therefore, the processor circuitry 1712 of FIG. 17 and/or the processor circuitry 1812 of FIG. 18 may additionally be implemented by combining the example microprocessor 1900 of FIG. 19 and the example FPGA circuitry 2000 of FIG. 20. In some such hybrid examples, a first portion of the machine readable instructions represented by the flowcharts of FIGS. 9-16 may be executed by one or more of the cores 1902 of FIG. 19, a second portion of the machine readable instructions represented by the flow charts of FIGS. 9-16 may be executed by the FPGA circuitry 2000 of FIG. 20, and/or a third portion of the machine readable instructions represented by the flowcharts of FIGS. 9-16 may be executed by an ASIC. It should be understood that some or all of the control circuitry 400 of FIG. 4 and/or the field device circuitry 500 of FIG. 5 may, thus, be instantiated at the same or different times. Some or all of the circuitry may be instantiated, for example, in one or more threads executing concurrently and/or in series. Moreover, in some examples, some or all of the control circuitry 400 of FIG. 4 and/or the field device circuitry 500 of FIG. 5 may be implemented within one or more virtual machines and/or containers executing on the microprocessor.

In some examples, the processor circuitry 1712 of FIG. 17 and/or the processor circuitry 1812 of FIG. 18 may be in one or more packages. For example, the microprocessor 1900 of FIG. 19 and/or the FPGA circuitry 2000 of FIG. 20 may be in one or more packages. In some examples, an XPU may be implemented by the processor circuitry 1712 of FIG. 17 and/or the processor circuitry 1812 of FIG. 18, which may be in one or more packages. For example, the XPU may include a CPU in one package, a DSP in another package, a GPU in yet another package, and an FPGA in still yet another package.

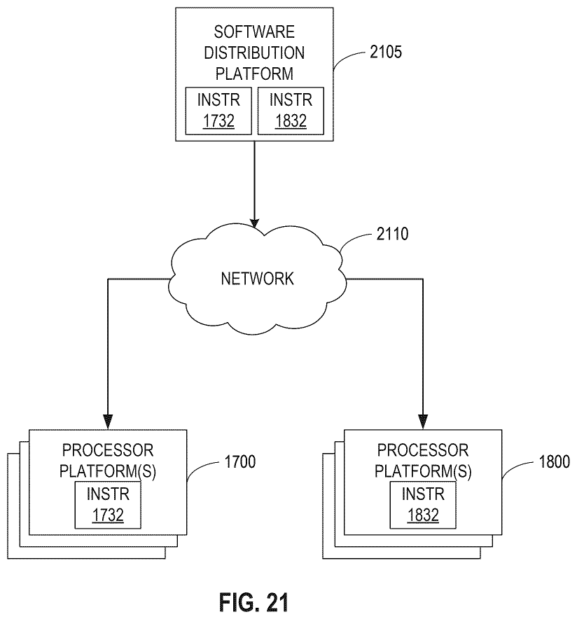

A block diagram illustrating an example software distribution platform 2105 to distribute software such as the example machine readable instructions 1732 of FIG. 17 and/or the example machine readable instructions 1832 of FIG. 18 to hardware devices owned and/or operated by third parties is illustrated in FIG. 21. The example software distribution platform 2105 may be implemented by any computer server, data facility, cloud service, etc., capable of storing and transmitting software to other computing devices. The third parties may be customers of the entity owning and/or operating the software distribution platform 2105. For example, the entity that owns and/or operates the software distribution platform 2105 may be a developer, a seller, and/or a licensor of software such as the example machine readable instructions 1732 of FIG. 17 and/or the example machine readable instructions 1832 of FIG. 18. The third parties may be consumers, users, retailers, OEMs, etc., who purchase and/or license the software for use and/or re-sale and/or sub-licensing. In the illustrated example, the software distribution platform 1705 includes one or more servers and one or more storage devices. The storage devices store the machine readable instructions 1732, which may correspond to the example machine readable instructions 900, 1000, 1100, 1300, 1500 of FIGS. 9, 10, 11, 13, and/or 15, as described above. The storage devices store the machine readable instructions 1832, which may correspond to the example machine readable instructions 1200, 1300, 1400, 1500, 1600 of FIGS. 12-16, as described above. The one or more servers of the example software distribution platform 2105 are in communication with an example network 2110, which may correspond to any one or more of the Internet and/or any of the example networks 1726, 1826 described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 1732, 1832 from the software distribution platform 2105. For example, the software, which may correspond to the example machine readable instructions 900, 1000, 1100, 1300, 1500 of FIGS. 9, 10, 11, 13, and/or 15, may be downloaded to the example processor platform 1700, which is to execute the machine readable instructions 1732 to implement the control circuitry 400 of FIG. 4. In some examples, the software, which may correspond to the example machine readable instructions 1200, 1300, 1400, 1500, 1600 of FIGS. 12-16, may be downloaded to the example processor platform 1800, which is to execute the machine readable instructions 1832 to implement the field device circuitry 500 of FIG. 5. In some examples, one or more servers of the software distribution platform 2105 periodically offer, transmit, and/or force updates to the software (e.g., the example machine readable instructions 1732 of FIG. 17 and/or the example machine readable instructions 1832 of FIG. 18) to ensure improvements, patches, updates, etc., are distributed and applied to the software at the end user devices.

From the foregoing, it will be appreciated that example systems, methods, apparatus, and articles of manufacture have been disclosed for sequence of event generation for a process control system. Disclosed systems, methods, apparatus, and articles of manufacture can capture sequence of events based on digital information from digital field devices rather than physical signals such as changes in voltage or current. Disclosed examples can capture sequence of events for analog process parameters rather than only discrete process parameters. Disclosed examples can time synchronize field devices together for the purpose of sequencing events. Disclosed examples can time synchronize digital field devices and I/O systems to accommodate legacy device signals associated with the I/O systems. Disclosed examples can configure field devices as a signaling/publisher field device and/or a subscriber field device through a computing system in communication with a controller. Disclosed examples can authenticate field devices to achieve improved security of a process control system.

Disclosed examples can prevent a network storm of events by identifying related events already broadcasted to a process control system prior to generating new events. Disclosed systems, methods, apparatus, and articles of manufacture improve the efficiency of using a computing device by reducing network traffic of a process control system via network storm event prevention. Disclosed systems, methods, apparatus, and articles of manufacture are accordingly directed to one or more improvement(s) in the operation of a machine such as a computer or other electronic and/or mechanical device.

Example methods, apparatus, systems, and articles of manufacture for sequence of event generation for a process control system. Further examples and combinations thereof include the following:

Example 1 includes an apparatus comprising at least one memory, machine readable instructions, and processor circuitry to at least one of execute or instantiate the machine readable instructions to obtain a first digital signal from a first field device in a process control system, the first digital signal representative of a first sensor data value labeled with a first timestamp, the first timestamp to be generated by the first field device, obtain a second digital signal from a second field device in the process control system, the second digital signal representative of a second sensor data value labeled with a second timestamp, the second timestamp to be generated by the second field device, and store a data association of the first sensor data value and the second sensor data value in a datastore, the data association representative of a sequence of events associated with the process control system, the sequence of events to include an ordering of the first sensor data value and the second sensor data value based on the first timestamp and the second timestamp.

Example 2 includes the apparatus of example 1, wherein the processor circuitry is to obtain the first digital signal and the second digital signal based on a network communication protocol.

Example 3 includes the apparatus of example 1, wherein the processor circuitry is to determine that at least one of the first sensor data value or the second sensor data value is representative of a logic zero or a logic one.

Example 4 includes the apparatus of example 1, wherein the processor circuitry is to determine that at least one of the first sensor data value or the second sensor data value is representative of an electrical current measurement or an electrical voltage measurement.

Example 5 includes the apparatus of example 1, wherein the processor circuitry is to synchronize at least one of a first clock of the first field device or a second clock of the second field device with a third clock associated with the processor circuitry.

Example 6 includes the apparatus of example 1, wherein the processor circuitry is to synchronize a first clock of the first field device with a second clock of the second field device.

Example 7 includes the apparatus of example 1, wherein the process control system includes an input/output (I/O) system and a third field device, and the processor circuitry is to obtain a third digital signal from the I/O system, and determine that the third digital signal is representative of a third sensor data value labeled with a third timestamp, the third sensor data value to be measured by the third field device, the third timestamp to be generated by the I/O system.

Example 8 includes the apparatus of example 1, wherein the processor circuitry is to transmit configuration data to the second field device, the configuration data to include an event subscription identifier, the event subscription identifier to identify the second field device as a subscriber to the first field device, and after an event is generated by the first field device, obtain the second digital signal from the second field device, the second field device to transmit the second digital signal after receiving the event from the first field device, the event including the event subscription identifier.

Example 9 includes the apparatus of example 1, wherein at least one of the first digital signal or the second digital signal are not associated with an event, the data association is a first data association, and the processor circuitry is to determine that the at least one of the first sensor data value or the second sensor data value are indicative of an anomalous condition associated with at least one of the first field device or the second field device, and store a second data association of metadata and the at least one of the first sensor data value or the second sensor data value, the metadata to identify the at least one of the first sensor data value or the second sensor data value as associated with the anomalous condition.

Example 10 includes at least one non-transitory machine readable medium comprising instructions that, when executed, cause processor circuitry to at least obtain a first digital signal from a first field device in a process control system, the first digital signal representative of a first sensor data value marked with a first timestamp, the first timestamp to be generated by the first field device, obtain a second digital signal from a second field device in the process control system, the second digital signal representative of a second sensor data value marked with a second timestamp, the second timestamp to be generated by the second field device, and store a data association of the first sensor data value and the second sensor data value in a datastore, the data association representative of a sequence of events associated with the process control system, the sequence of events to include an ordering of the first sensor data value and the second sensor data value based on the first timestamp and the second timestamp.

Example 11 includes the at least one non-transitory machine readable medium of example 10, wherein the instructions, when executed, cause the processor circuitry to obtain the first digital signal and the second digital signal based on a network communication protocol.

Example 12 includes the at least one non-transitory machine readable medium of example 10, wherein the instructions, when executed, cause the processor circuitry to determine that at least one of the first sensor data value or the second sensor data value is representative of a logic zero or a logic one.

Example 13 includes the at least one non-transitory machine readable medium of example 10, wherein the instructions, when executed, cause the processor circuitry to determine that at least one of the first sensor data value or the second sensor data value is representative of an electrical current measurement or an electrical voltage measurement.

Example 14 includes the at least one non-transitory machine readable medium of example 10, wherein the instructions, when executed, cause the processor circuitry to synchronize at least one of a first clock of the first field device or a second clock of the second field device with a third clock associated with the processor circuitry.

Example 15 includes the at least one non-transitory machine readable medium of example 10, wherein the instructions, when executed, cause the processor circuitry to synchronize a first clock of the first field device with a second clock of the second field device.

Example 16 includes the at least one non-transitory machine readable medium of example 10, wherein the process control system includes an input/output (I/O) system and a third field device, and the instructions, when executed, cause the processor circuitry to obtain a third digital signal from the I/O system, and determine that the third digital signal is representative of a third sensor data value labeled with a third timestamp, the third sensor data value to be measured by the third field device, the third timestamp to be generated by the I/O system.

Example 17 includes the at least one non-transitory machine readable medium of example 10, wherein the instructions, when executed, cause the processor circuitry to cause transmission of configuration data to the second field device, the configuration data to include an event subscription identifier, the event subscription identifier to identify the second field device as a subscriber to the first field device, and after an event is generated by the first field device, obtain the second digital signal from the second field device, the second field device to transmit the second digital signal after receiving the event from the first field device, the event including the event subscription identifier.

Example 18 includes the at least one non-transitory machine readable medium of example 10, wherein at least one of the first digital signal or the second digital signal are not associated with an event, the data association is a first data association, and the instructions, when executed, cause the processor circuitry to determine that the at least one of the first sensor data value or the second sensor data value are indicative of an abnormal condition associated with at least one of the first field device or the second field device, and store a second data association of metadata and the at least one of the first sensor data value or the second sensor data value, the metadata to identify the at least one of the first sensor data value or the second sensor data value as associated with the abnormal condition.

Example 19 includes a method comprising obtaining a first digital signal from a first field device in a process control system, the first digital signal representative of a first sensor data value labeled with a first timestamp, the first timestamp generated by the first field device, obtaining a second digital signal from a second field device in the process control system, the second digital signal representative of a second sensor data value labeled with a second timestamp, the second timestamp generated by the second field device, and storing a data association of the first sensor data value and the second sensor data value in a datastore, the data association representative of a sequence of events associated with the process control system, the sequence of events including an ordering of the first sensor data value and the second sensor data value based on the first timestamp and the second timestamp.

Example 20 includes the method of example 19, wherein the first digital signal and the second digital signal are based on a network communication protocol.

Example 21 includes the method of example 19, wherein at least one of the first sensor data value or the second sensor data value is representative of a logic zero or a logic one.

Example 22 includes the method of example 19, wherein at least one of the first sensor data value or the second sensor data value is representative of an electrical current measurement or an electrical voltage measurement.

Example 23 includes the method of example 19, wherein the process control system includes a controller, and the method further including synchronizing at least one of a first clock of the first field device or a second clock of the second field device with a third clock the controller.

Example 24 includes the method of example 19, further including synchronizing a first clock of the first field device with a second clock of the second field device.

Example 25 includes the method of example 19, wherein the process control system includes a controller, an input/output (I/O) system, and a third field device, and the method further including obtaining a third digital signal from the I/O system, the third digital signal representative of a third sensor data value labeled with a third timestamp, the third sensor data value measured by the third field device, the third timestamp generated by the I/O system.

Example 26 includes the method of example 19, further including transmitting configuration data to the second field device, the configuration data including an event subscription identifier, the event subscription identifier to identify the second field device as a subscriber to the first field device, and after an event is generated by the first field device, obtaining the second digital signal from the second field device, the second field device to transmit the second digital signal after receiving the event from the first field device, the event including the event subscription identifier.

Example 27 includes the method of example 19, wherein at least one of the first digital signal or the second digital signal are not associated with an event, the data association is a first data association, and the method further including identifying the at least one of the first sensor data value or the second sensor data value as indicative of an atypical condition associated with at least one of the first field device or the second field device, and store a second data association of metadata and the at least one of the first sensor data value or the second sensor data value, the metadata to identify the at least one of the first sensor data value or the second sensor data value as associated with the atypical condition.

Example 28 includes an apparatus comprising at least one memory. machine readable instructions, and processor circuitry to at least one of execute or instantiate the machine readable instructions to at least after a determination that a measurement period associated with a field device in a process control system is triggered, record a timestamp at the field device during the measurement period, record a sensor measurement associated with the timestamp at the field device, cause transmission of a digital signal representative of at least one of the timestamp or the sensor measurement from the field device to an electronic device using a network communication protocol, and cause a generation of a sequence of events for the field device based on the digital signal.

Example 29 includes the apparatus of example 28, wherein the timestamp is a first timestamp recorded at a beginning of the measurement period, the sensor measurement is a first measurement, the digital signal is a first digital signal, and the processor circuitry is to record a second timestamp at the field device at an end of the measurement period, record a second sensor measurement associated with the second timestamp, cause transmission of a second digital signal representative of the second timestamp and the second sensor measurement from the field device to the electronic device using the network communication protocol, and cause the generation of the sequence of events for the field device based on at least one of the first digital signal or the second digital signal.

Example 30 includes the apparatus of example 28, wherein the timestamp is a first timestamp at a beginning of the measurement period. the sensor measurement is one of a plurality of sensor measurements, and the processor circuitry is to record a minimum value of the plurality of sensor measurements, record a maximum value of the plurality of sensor measurements, and cause transmission of the first timestamp, a second timestamp associated with an end of the measurement period, the minimum value, and the maximum value to the electronic device using the network communication protocol.

Example 31 includes the apparatus of example 28, wherein the field device is a first field device, the determination is a first determination, and the processor circuitry is to receive an event at the first field device from a second field device, determine that the event includes an event subscription identifier, determine that the first field device is a subscriber of the second field device based on the event subscription identifier, and cause transmission of the digital signal to the electronic device after a second determination that the first field device is a subscriber of the second field device.

Example 32 includes the apparatus of example 31, wherein the event is a first event, the determination is a first determination, and the processor circuitry is to, after a second determination that the second field device received the first event, determine not to broadcast a second event from the second field device to one or more subscribers of the second field device.

Example 33 includes the apparatus of example 31, wherein the timestamp is a first timestamp, the event to include event data associated with a process control event, and the event data to include at least one of the event subscription identifier, an event identifier to identify the event, an event type to identify a type of the event, a second timestamp at which the event is observed, or a field device identifier to identify the first field device.

Example 34 includes at least one non-transitory computer readable storage medium comprising instructions that, when executed, cause processor circuitry to at least after a determination that a measurement period associated with a field device in a process control system is triggered, record a timestamp at the field device during the measurement period, record a sensor measurement associated with the timestamp at the field device, cause transmission of a digital signal representative of at least one of the timestamp or the sensor measurement from the field device to an electronic device using a network communication protocol, and cause a generation of a sequence of events for the field device based on the digital signal.

Example 35 includes the at least one non-transitory computer readable storage medium of example 34, wherein the timestamp is a first timestamp recorded at a beginning of the measurement period, the sensor measurement is a first measurement, the digital signal is a first digital signal, and the instructions, when executed, cause the processor circuitry to record a second timestamp at the field device at an end of the measurement period, record a second sensor measurement associated with the second timestamp, cause transmission of a second digital signal representative of the second timestamp and the second sensor measurement from the field device to the electronic device using the network communication protocol, and cause the generation of the sequence of events for the field device based on at least one of the first digital signal or the second digital signal.

Example 36 includes the at least one non-transitory computer readable storage medium of example 34, wherein the timestamp is a first timestamp at a beginning of the measurement period, the sensor measurement is one of a plurality of sensor measurements, and the instructions, when executed, cause the processor circuitry to record a minimum value of the plurality of sensor measurements, record a maximum value of the plurality of sensor measurements, and cause transmission of the first timestamp, a second timestamp associated with an end of the measurement period, the minimum value, and the maximum value to the electronic device using the network communication protocol.

Example 37 includes the at least one non-transitory computer readable storage medium of example 34, wherein the field device is a first field device, the determination is a first determination, and the instructions, when executed, cause the processor circuitry to receive an event at the first field device from a second field device, determine that the event includes an event subscription identifier, determine that the first field device is a subscriber of the second field device based on the event subscription identifier, and cause transmission of the digital signal to the electronic device after a second determination that the first field device is a subscriber of the second field device.

Example 38 includes the at least one non-transitory computer readable storage medium of example 37, wherein the event is a first event, the determination is a first determination, and the instructions, when executed, cause the processor circuitry to, after a second determination that the second field device received the first event, determine not to broadcast a second event from the second field device to one or more subscribers of the second field device.

Example 39 includes the at least one non-transitory computer readable storage medium of example 37, wherein the timestamp is a first timestamp, the event to include event data associated with a process control event, and the event data to include at least one of the event subscription identifier, an event identifier to identify the event, an event type to identify a type of the event, a second timestamp at which the event is observed, or a field device identifier to identify the first field device.

Example 40 includes a method comprising after determining that a measurement period associated with a field device in a process control system is triggered. recording a timestamp at the field device during the measurement period, recording a sensor measurement associated with the timestamp at the field device, transmitting a digital signal representative of at least one of the timestamp or the sensor measurement from the field device to an electronic device using a network communication protocol, and causing a generation of a sequence of events for the field device based on the digital signal.

Example 41 includes the method of example 40, wherein the timestamp is a first timestamp recorded at a beginning of the measurement period, the sensor measurement is a first measurement, the digital signal is a first digital signal, and the method further including recording a second timestamp at the field device at an end of the measurement period, recording a second sensor measurement associated with the second timestamp, transmitting a second digital signal representative of the second timestamp and the second sensor measurement from the field device to the electronic device using the network communication protocol, and causing the generation of the sequence of events for the field device based on at least one of the first digital signal or the second digital signal.

Example 42 includes the method of example 40, wherein the timestamp is a first timestamp at a beginning of the measurement period, the sensor measurement is one of a plurality of sensor measurements, and the method further including recording a minimum value of the plurality of sensor measurements, recording a maximum value of the plurality of sensor measurements, and transmitting the first timestamp, a second timestamp associated with an end of the measurement period, the minimum value, and the maximum value to the electronic device using the network communication protocol.

Example 43 includes the method of example 40, wherein the field device is a first field device, and the method further including receiving an event at the first field device from a second field device, determining that the event includes an event subscription identifier, determining that the first field device is a subscriber of the second field device based on the event subscription identifier, and transmitting the digital signal to the electronic device after determining that the first field device is a subscriber of the second field device.

Example 44 includes the method of example 43, wherein the event is a first event, and the method further including, after determining that the second field device received the first event, determining not to broadcast a second event from the second field device to one or more subscribers of the second field device.

Example 45 includes the method of example 43, wherein the timestamp is a first timestamp, the event including event data associated with a process control event, the event data including at least one of the event subscription identifier, an event identifier to identify the event, an event type to identify a type of the event, a second timestamp at which the event is observed, or a field device identifier to identify the first field device.

The following claims are hereby incorporated into this Detailed Description by this reference. Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

1. An apparatus comprising:
at least one memory:
machine readable instructions: and processor circuitry to at least one of execute or instantiate the machine readable instructions to:
obtain a first digital signal from a first field device in a process control system, the first digital signal representative of a first sensor data value labeled with a first timestamp, the first timestamp to be generated by the first field device:
obtain a second digital signal from a second field device in the process control system, the second digital signal representative of a second sensor data value labeled with a second timestamp, the second timestamp to be generated by the second field device: and
store a data association of the first sensor data value and the second sensor data value in a datastore, the data association representative of a sequence of events associated with the process control system, the sequence of events to include an ordering of the first sensor data value and the second sensor data value based on the first timestamp and the second timestamp.

2. The apparatus of claim 1, wherein the processor circuitry is to obtain the first digital signal and the second digital signal based on a network communication protocol.

3. (canceled) The apparatus of claim 1, wherein the processor circuitry is to determine that at least one of the first sensor data value or the second sensor data value is representative of a logic zero or a logic one.

4. (canceled)

5. The apparatus of claim 1, wherein the processor circuitry is to synchronize at least one of a first clock of the first field device or a second clock of the second field device with a third clock associated with the processor circuitry.

6. The apparatus of claim 1, wherein the processor circuitry is to synchronize a first clock of the first field device with a second clock of the second field device.

7. The apparatus of claim 1, wherein the process control system includes an input/output (I/O) system and a third field device, and the processor circuitry is to:
obtain a third digital signal from the I/O system: and
determine that the third digital signal is representative of a third sensor data value labeled with a third timestamp, the third sensor data value to be measured by the third field device, the third timestamp to be generated by the I/O system.

8. The apparatus of claim 1, wherein the processor circuitry is to:
transmit configuration data to the second field device, the configuration data to include an event subscription identifier, the event subscription identifier to identify the second field device as a subscriber to the first field device; and
after an event is generated by the first field device, obtain the second digital signal from the second field device, the second field device to transmit the second digital signal after receiving the event from the first field device, the event including the event subscription identifier.

9. The apparatus of claim 1, wherein at least one of the first digital signal or the second digital signal are not associated with an event, the data association is a first data association, and the processor circuitry is to:
determine that the at least one of the first sensor data value or the second sensor data value are indicative of an anomalous condition associated with at least one of the first field device or the second field device; and
store a second data association of metadata and the at least one of the first sensor data value or the second sensor data value, the metadata to identify the at least one of the first sensor data value or the second sensor data value as associated with the anomalous condition.

10. At least one non-transitory machine readable medium comprising instructions that, when executed, cause processor circuitry to at least:
obtain a first digital signal from a first field device in a process control system, the first digital signal representative of a first sensor data value marked with a first timestamp, the first timestamp to be generated by the first field device;
obtain a second digital signal from a second field device in the process control system, the second digital signal representative of a second sensor data value marked with a second timestamp, the second timestamp to be generated by the second field device; and
store a data association of the first sensor data value and the second sensor data value in a datastore, the data association representative of a sequence of events associated with the process control system, the sequence of events to include an ordering of the first sensor data value and the second sensor data value based on the first timestamp and the second timestamp.

11. The at least one non-transitory machine readable medium of claim 10, wherein the instructions, when executed, cause the processor circuitry to obtain the first digital signal and the second digital signal based on a network communication protocol.

12. (canceled)

13. (canceled)

14. The at least one non-transitory machine readable medium of claim 10, wherein the instructions, when executed, cause the processor circuitry to synchronize at least one of a first clock of the first field device or a second clock of the second field device with a third clock associated with the processor circuitry.

15. The at least one non-transitory machine readable medium of claim 10, wherein the instructions, when executed, cause the processor circuitry to synchronize a first clock of the first field device with a second clock of the second field device.

16. The at least one non-transitory machine readable medium of claim 10, wherein the process control system includes an input/output (I/O) system and a third field device, and the instructions, when executed, cause the processor circuitry to:
obtain a third digital signal from the I/O system: and
determine that the third digital signal is representative of a third sensor data value labeled with a third timestamp, the third sensor data value to be measured by the third field device, the third timestamp to be generated by the I/O system.

17. The at least one non-transitory machine readable medium of claim 10, wherein the instructions, when executed, cause the processor circuitry to:
cause transmission of configuration data to the second field device, the configuration data to include an event subscription identifier, the event subscription identifier to identify the second field device as a subscriber to the first field device; and
after an event is generated by the first field device, obtain the second digital signal from the second field device, the second field device to transmit the second digital signal after receiving the event from the first field device, the event including the event subscription identifier.

18. The at least one non-transitory machine readable medium of claim 10, wherein at least one of the first digital signal or the second digital signal are not associated with an event, the data association is a first data association, and the instructions, when executed, cause the processor circuitry to:
determine that the at least one of the first sensor data value or the second sensor data value are indicative of an abnormal condition associated with at least one of the first field device or the second field device; and
store a second data association of metadata and the at least one of the first sensor data value or the second sensor data value, the metadata to identify the at least one of the first sensor data value or the second sensor data value as associated with the abnormal condition.

19. A method comprising:
obtaining a first digital signal from a first field device in a process control system, the first digital signal representative of a first sensor data value labeled with a first timestamp, the first timestamp generated by the first field device:
obtaining a second digital signal from a second field device in the process control system, the second digital signal representative of a second sensor data value labeled with a second timestamp, the second timestamp generated by the second field device; and
storing a data association of the first sensor data value and the second sensor data value in a datastore, the data association representative of a sequence of events associated with the process control system, the sequence of events including an ordering of the first sensor data value and the second sensor data value based on the first timestamp and the second timestamp.

20. (canceled)

21. (canceled)

22. (canceled)

23. (canceled)

24. The method of claim 19, further including synchronizing a first clock of the first field device with a second clock of the second field device.

25. The method of claim 19, wherein the process control system includes a controller, an input/output (I/O) system, and a third field device, and the method further including obtaining a third digital signal from the I/O system, the third digital signal representative of a third sensor data value labeled with a third timestamp, the third sensor data value measured by the third field device, the third timestamp generated by the I/O system.

26. The method of claim 19, further including:
transmitting configuration data to the second field device, the configuration data including an event subscription identifier, the event subscription identifier to identify the second field device as a subscriber to the first field device; and
after an event is generated by the first field device, obtaining the second digital signal from the second field device, the second field device to transmit the second digital signal after receiving the event from the first field device, the event including the event subscription identifier.

27. The method of claim 19, wherein at least one of the first digital signal or the second digital signal are not associated with an event, the data association is a first data association, and the method further including:
identifying the at least one of the first sensor data value or the second sensor data value as indicative of an atypical condition associated with at least one of the first field device or the second field device; and
store a second data association of metadata and the at least one of the first sensor data value or the second sensor data value, the metadata to identify the at least one of the first sensor data value or the second sensor data value as associated with the atypical condition.

28.-45. (canceled)
